(19) United States
(12) Patent Application Publication
(10) Pub. No.: US 2024/0259159 A1
(43) Pub. Date: Aug. 1, 2024

(54) IN-CHANNEL NARROWBAND COMPANION AIR-INTERFACE ASSISTED WIDEBAND TRX FREQUENCY CORRECTION PROCEDURES

(71) Applicant: INTERDIGITAL PATENT HOLDINGS, INC., Wilmington, DE (US)

(72) Inventors: Alpaslan Demir, East Meadow, NY (US); Sanjay Goyal, Deer Park, NY (US); Patrick Cabrol, Bayshore, NY (US); Muhammad Fazili, Audubon, PA (US); Tanbir Haque, Jackson Heights, NY (US); Ravikumar Pragada, Warrington, PA (US)

(73) Assignee: INTERDIGITAL PATENT HOLDINGS, INC., Wilmington, DE (US)

(21) Appl. No.: 18/560,778

(22) PCT Filed: May 19, 2022
(86) PCT No.: PCT/US2022/029967

§ 371 Date: Nov. 14, 2023

Related U.S. Application Data
(60) Provisional application No. 63/191,108, filed on May 20, 2021.

(51) Int. Cl. H04L 5/00

(52) U.S. Cl. CPC H04L 5/0051; H04L 5/0055

(57) ABSTRACT

A method and WTRU to support an in-channel narrowband companion air interface (NB-CAI) assisted wideband (WB) frequency error correction procedure is disclosed. The method may comprise a WTRU sending, via the NB-CAI, a frequency convergence reference signal (FCRS) scheduling request to a network node and receiving, via the NB-CAI, a FCRS scheduling response from the network node. The method may comprise receiving, via a wideband air interface (WB-AI), periodic FCRSs from the network node based on the received FCRS scheduling response and sending, via the NB-CAI, a request to the network node to change a rate of FCRS transmissions. The FCRS scheduling request may comprise range information. The request to change a rate of FCRS transmissions may be based on a convergence indication. The request to change a rate of FCRS transmissions may comprise a configuration identification of a selected FCRS configuration from a set of FCRS configurations.

### CROSS-REFERENCE TO RELATED APPLICATIONS

This application claims the benefit of U.S. Provisional Application No. 63/191,108, filed May 20, 2021 the contents of which are incorporated herein by reference.

### BACKGROUND

Existing enhanced Mobile Broad-Band (eMBB) systems utilize a single wideband air-interface (WB-AI) for both control and data planes. Utilization of sub-Terahertz (THz) wideband transceivers only for both control and data planes will be prohibitive in energy consumption and does not lend itself well to battery operated portable electronics. Due to the elevated phase noise of sub-THz voltage control oscillators (VCOs) and poor drift characteristics of high frequency references, more frequent automatic frequency control (AFC) updates are required. Implementing an AFC using only the WB-AI may be energy prohibitive. In a WB-AI only approach, the periodic processing of sequences/messages either in the transmit or receive chains may result in low battery life. Furthermore, mobile sub-THz devices will be required to monitor control plane signals (e.g., frequency synchronization) more frequently due to: (1) reduced frequency stability and higher drift of sub-THz local oscillators, compared to more familiar sub-6 GHz devices, and (2) elevated Doppler effects at higher frequency and highly directional deployment for a given wireless transmit/receive unit (WTRU) velocity.

### SUMMARY

A method and wireless transmit/receive unit (WTRU) to support an in-channel narrowband companion air interface (NB-CAI) assisted wideband (WB) frequency error correction procedure is disclosed. The method may comprise a WTRU sending, via the NB-CAI, a frequency convergence reference signal (FCRS) scheduling request to a network node. The method may comprise receiving, via the NB-CAI, a FCRS scheduling response from the network node. The method may comprise receiving, via a wideband air interface (WB-AI), periodic FCRSs from the network node based on the received FCRS scheduling response. The method may comprise sending, via the NB-CAI, a request to the network node to change a rate of FCRS transmissions. The request to change a rate of FCRS transmissions may be based on a convergence indication. The FCRS scheduling response may comprise at least one of: FCRS sequence information, periodicity, initial time offset, frequency domain allocation information, and beam information. The FCRS scheduling request may comprise range information. The range information may indicate a physical distance between the WTRU and the network node. An initial frequency offset may be based on an estimated frequency offset error measured at the NB-CAI. The method may comprise performing measurements on the received periodic FCRSs. The request to change a rate of FCRS transmissions may be further based on a condition that a periodicity of the FCRS transmissions are equal to or below a maximum periodicity. The request to change a rate of FCRS transmissions may comprise a configuration identification of a selected FCRS configuration from a set of FCRS configurations. The selected FCRS configuration may be based on the convergence indication. The method may comprise receiving an acknowledgement (ACK) from the network node in response to sending the request to change a rate of FCRS transmissions The ACK may comprise a new FCRS schedule configuration. The method may comprise receiving periodic FCRSs from the network node based on the new FCRS schedule configuration. The convergence indication may be based on a convergence threshold.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating antenna gain;

FIG. 3 is a diagram illustrates antenna beamwidth;

FIG. 4 is a diagram illustrating antenna gain vs. antenna bandwidth;

FIG. 5 is a diagram illustrating wideband vs. narrowband signal beam projection on a plane;

FIG. 6 is a diagram illustrating sub-THz wideband radio architecture used to estimate power consumption;

FIG. 7 is a diagram illustrating LTE C-RS Resource Element placement in one RB;

FIG. 8 is a diagram illustrating tracking reference signals consisting of 4 one-port, density-3 CSI-RS located in two consecutive slots;

FIG. 9 is a diagram illustrating tracking reference signals consisting of 2 one port, density-3 CSI-RS located in single slot;

FIG. 10 is a diagram illustrating in-channel NB Companion air-interface and WB TRX;

FIG. 11 is a diagram illustrating a WTRU triggered frequency error correction procedure for a WB-AI;

FIG. 12 is a diagram illustrating a WTRU method to dynamically update the FCRS periodicity;

FIG. 13 is a diagram illustrating a gNB initiated frequency error correction procedure for a WB-AI;

FIG. 14 is a diagram illustrating an example of FCRS transmissions and reception with different states of the convergence;

FIG. 15 is a diagram illustrating an example of FCRS configuration and reception for the WB-AI's inactive state;

FIG. 16 is a diagram illustrating an example of FCRS reception during the inactive state showing the transition from the deep-sleep state to micro-sleep state;

FIG. 17(a) is a diagram illustrating an example of FCRS transmissions;

FIG. 17(b) is a diagram illustrating an example of FCRS transmissions;

FIG. 17(c) is a diagram illustrating an example of FCRS transmissions;

FIG. 18 is a diagram illustrating an example of FCRS rate adaptation for the WB-AI's frequency error correction procedure during the inactive state;

FIG. 19 is a diagram illustrating an example of WB-AI FCRS configuration when beam switch occurs, and the WTRU uses the same FCRS configuration over both the beams; and

FIG. 20 is a diagram illustrating an example of WB-AI FCRS configuration when beam switch occurs, and the WTRU determines to use a higher rate of FCRS transmission due to the high mobility scenario.

### DETAILED DESCRIPTION

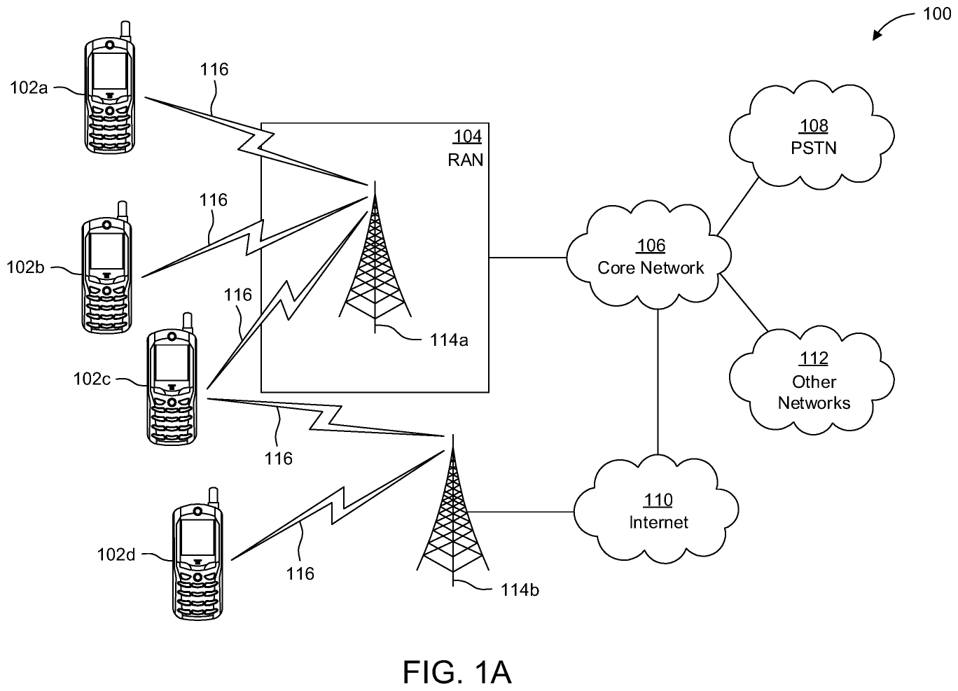

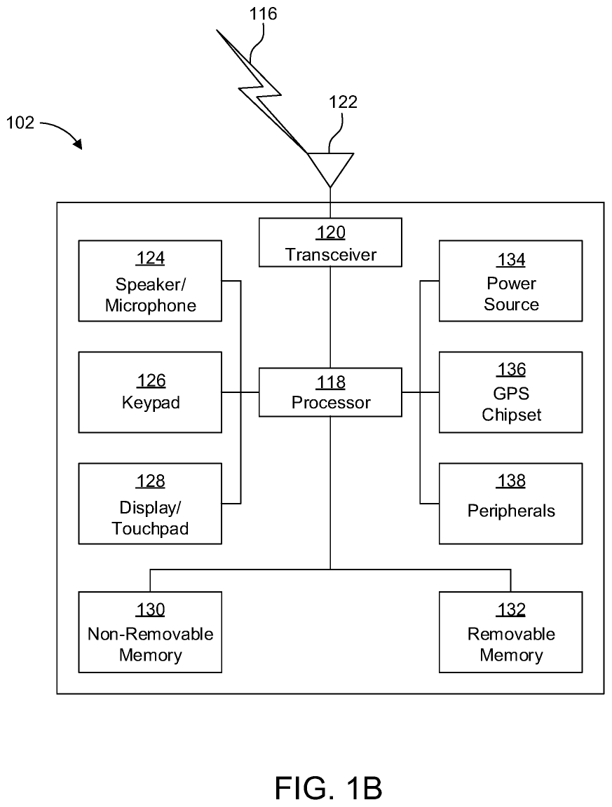

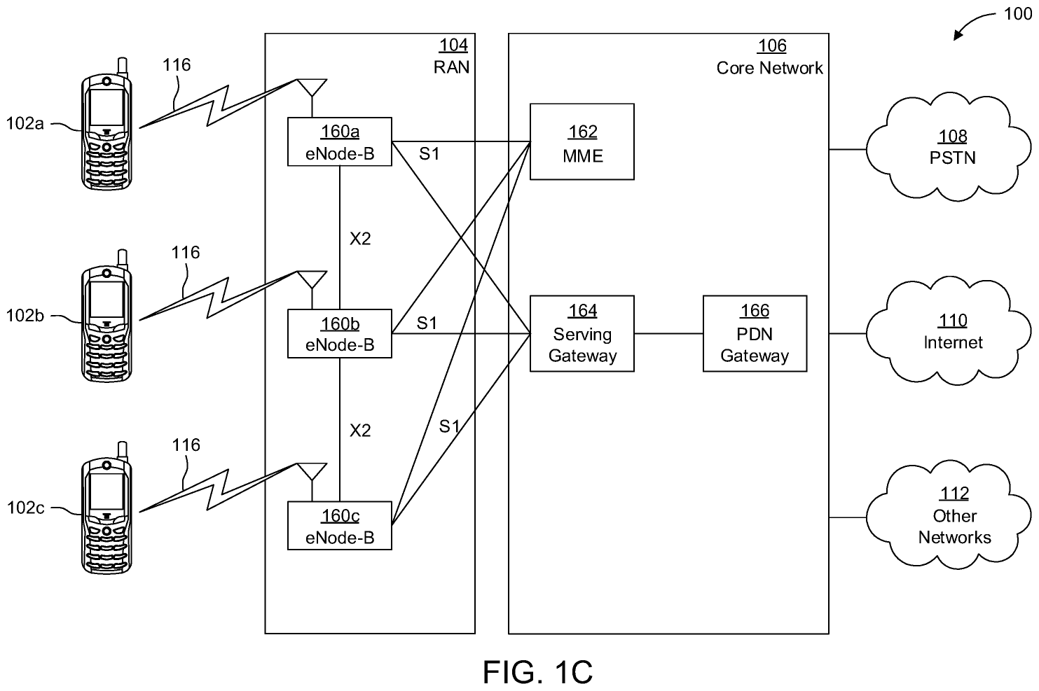

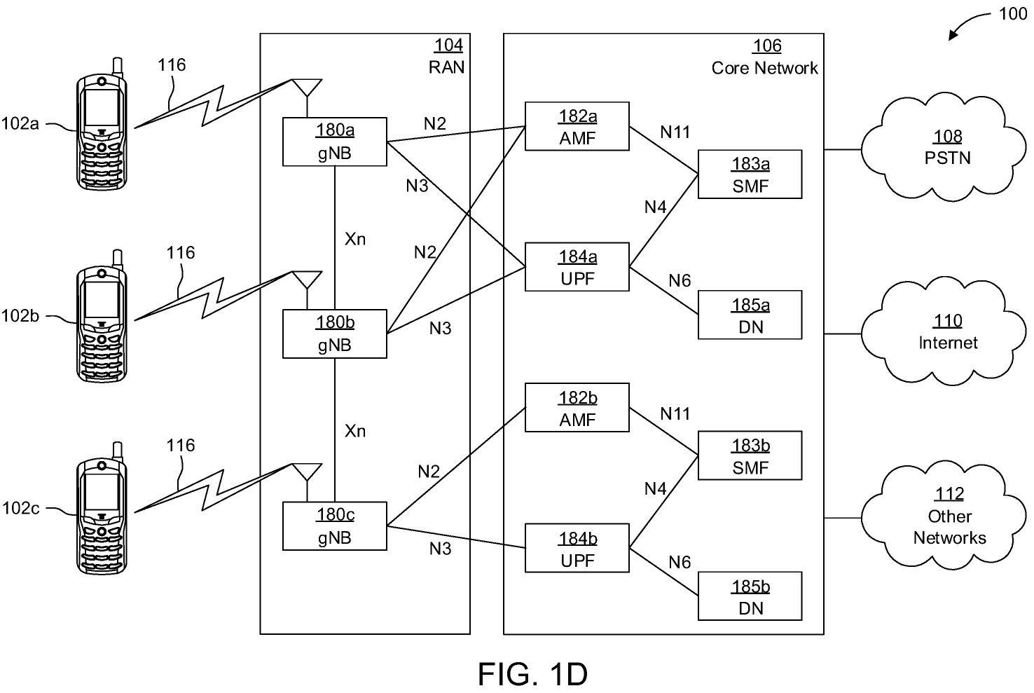

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The bandwidth of an antenna may be considered as a range of frequencies, on either side of a center frequency, where the antenna characteristics, such as impedance, beamwidth, polarization, and gain, are within an acceptable value of those at the center frequency.

For broadband antennas, the bandwidth may be expressed as a ratio of the upper-to-lower frequencies of acceptable operation. For example, a 10:1 bandwidth may indicate that the upper frequency is 10 times greater than the lower frequency.

For narrowband antennas, the bandwidth may be expressed as a percentage of the frequency difference (e.g. upper minus lower) over the center frequency of the bandwidth. For example, a 5% bandwidth may indicate that the frequency difference of acceptable operation is 5% of the center frequency of the bandwidth.

Antenna characteristics such as impedance, pattern, polarization, among others, may be invariant if the electrical dimensions remain unchanged. That is, if all the physical dimensions are reduced by a factor while the operating frequency is increased by the same factor.

The gain or directivity of an antenna may be a ratio of the radiation intensity in a given direction to the radiation intensity averaged over all directions. Directivity and gain may be used interchangeably herein. Directivity may neglect antenna losses such as dielectric, resistance, polarization, and voltage standing wave ratio (VSWR) losses.

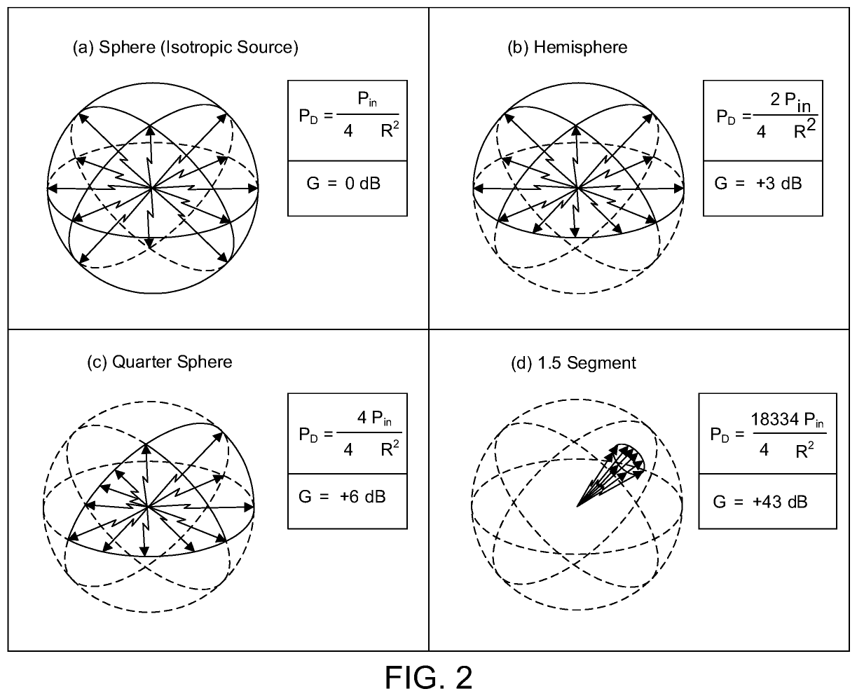

Normalizing a radiation pattern by an integrated total power may yield the directivity of the antenna. When the angle in which the radiation is constrained is reduced, the directive gain goes up, as shown in FIG. 2.

However, real antennas do not have an ideal radiation distribution. Energy varies with angular displacement and losses may occur due to sidelobes. A real antenna model may be approximated using radiation pattern and beamwidth measurements to choose from a combination of ideal antenna models.

The beamwidth of a main lobe along with a side lobe level may be controlled by a relative amplitude excitation (distribution) between the elements of the array. There may be a trade-off between the beamwidth and the side lobe level based on the amplitude distribution.

A beamwidth definition may be a Half-Power Beamwidth (HPBW), which may be defined as: “In a plane containing the direction of the maximum of a beam, the angle between the two directions in which the radiation intensity is one-half value of the beam.”

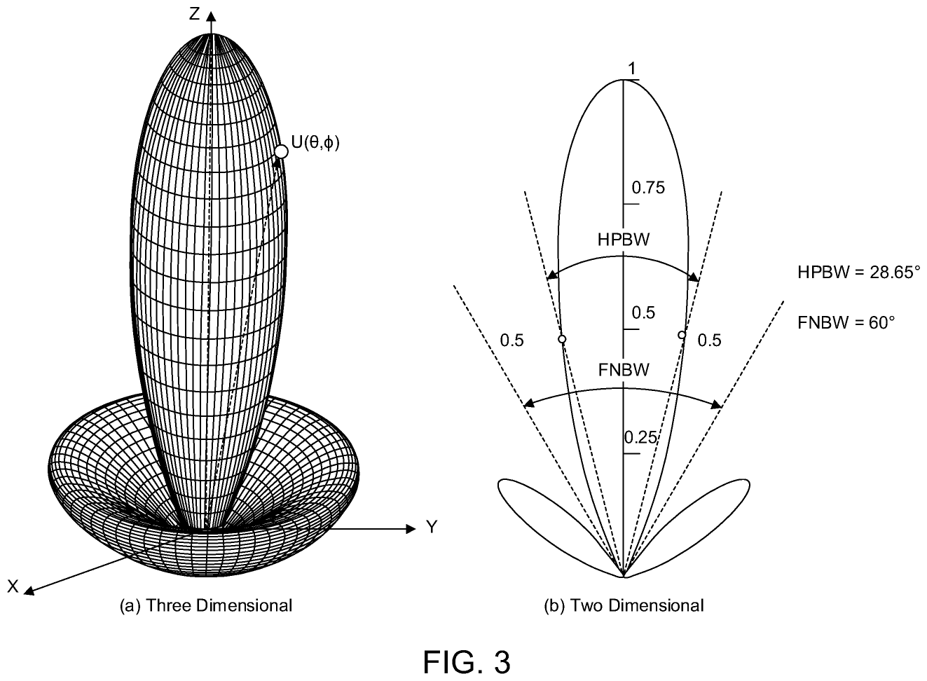

Another beamwidth definition may be based on an angular separation between the first nulls of an antenna pattern, referred to as the First-Null Beamwidth (FNBW). Both the HPBW and FNBW radiation pattern are shown in FIG. 3. In practice, the term beamwidth, with no other qualification, may refer to HPBW.

The beamwidth of an antenna may be used to describe the resolution capabilities of an antenna to distinguish between two adjacent radiating sources. This antenna resolution capability to distinguish between two sources is equal to half the first-null beamwidth (FNBW/2), which may be used to approximate the HPBW. That is, two sources separated by angular distances equal or greater than FNBW/2˜HPBW of an antenna with a uniform distribution may be resolved.

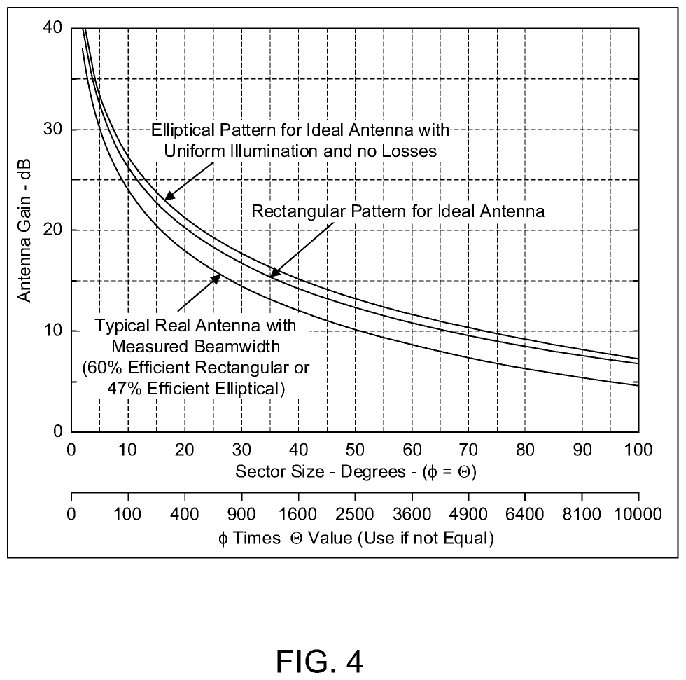

FIG. 4 shows an example of antenna gain v. antenna bandwidth. The upper plot of FIG. 4 shows the gain for an ideal antenna pattern using an elliptical model. The middle plot of FIG. 4 shows the gain for an ideal antenna using a rectangular model. The lower plot of FIG. 4 shows the gain of a typical real antenna, with either a rectangular model using an efficiency of 60%, or an elliptical antenna model using an efficiency of 47%.

Table 1 below compares the performance of a wideband transceiver versus a narrowband transceiver operating in a Sub-THz frequency range.

The following design assumptions are made:
Carrier frequency: 300 GHz
Wideband Radio EVM=−26 dB
Narrowband Radio EVM=−40 dB
Fixed link distance=13 m
Wideband channel BW: 25 GHz
Narrowband channel BW: 20 MHz, 250 MHz

TABLE 1

| | Wideband TRX | | Narrowband TRX | | | |
|---|---|---|---|---|---|---|
| | OFDM/16QAM | | CPM | | CPM | |
| | (25 GHz) | | (250 MHz) | | (20 MHz) | |
| PA back-off | −9 | dB | −1.5 | dB | −1.5 | dB |
| Antenna gain | 35 | dBi | 29 | dBi | 26 | dBi |
| Beam width | 3 | deg | 7 | deg | 11 | deg |
| Illuminated area | .364 | m\hat{ }2 | 1.986 | m\hat{ }2 | 4.922 | m\hat{ }2 |

| | | | |
|---|---|---|---|
| Area ratio | 1 | 5.46 | 13.52 |

To maintain a 13 m link operation and satisfy a power amplifier (PA) back-off requirement for OFDM/16QAM, a high antenna gain of 35 dBi is required for the wideband (WB) transceiver (TRX), resulting in a narrower beamwidth of 3 degrees. On the other hand, the narrowband (NB) TRX with 20 MHz of modulation bandwidth only requires 26 dBi of antenna gain, resulting in a coverage area approximately 13.4 times larger than the reference WB TRX equipped with a high gain antenna. Error! Reference source not found.

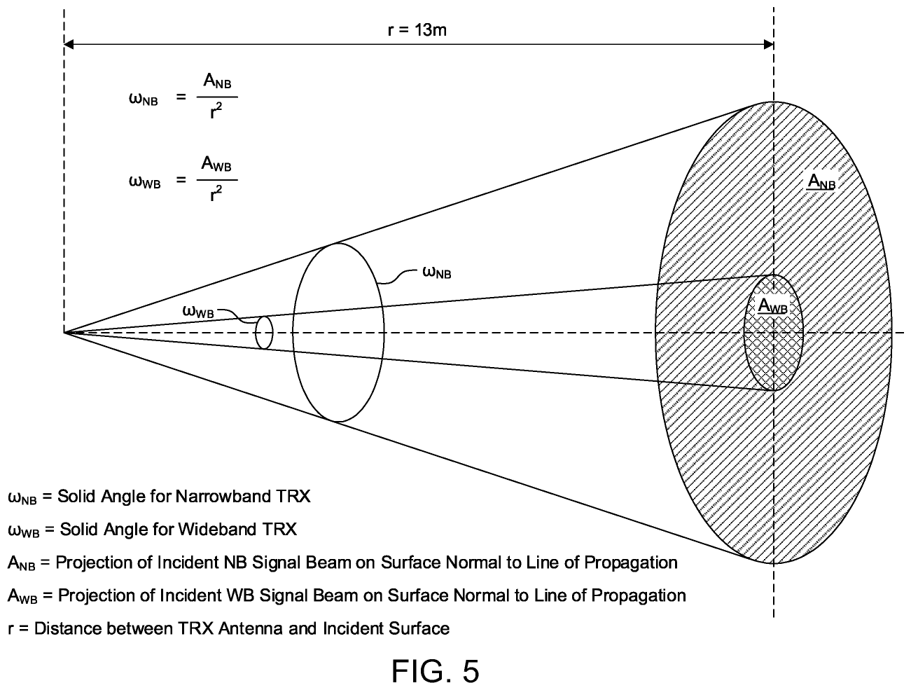

FIG. 5 shows an example of a wideband vs. narrowband signal beam projection on a plane. FIG. 5 shows the surface projection of both narrowband and wideband signals along with their respective antenna beamwidth at distance r of 13 m. The NB TRX with its wider beam pattern may have the ability to scan a given coverage area in a shorter time period. For a NB TRX with a modulation bandwidth of 250 MHz, the coverage area is increased by a factor of approximately five and a half.

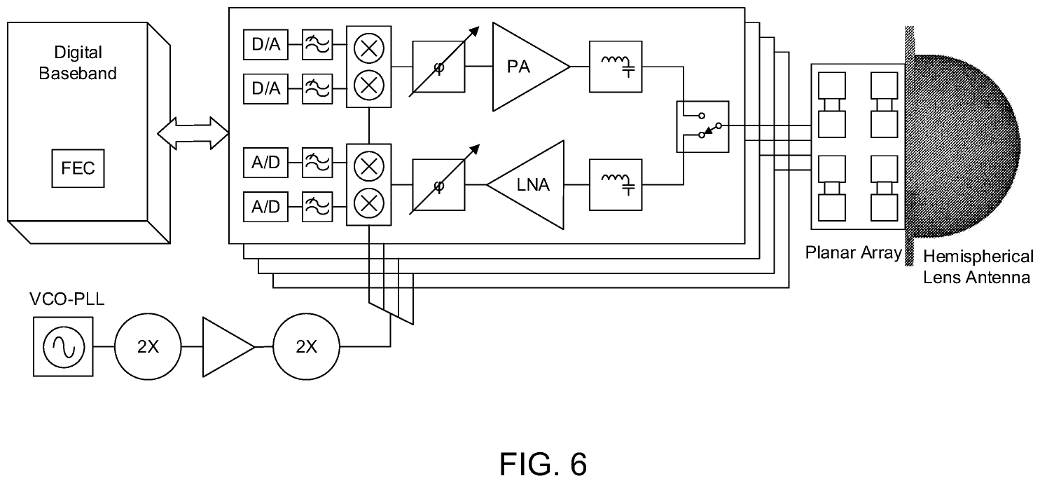

FIG. 6 shows an example architecture of a sub-THz wideband radio used to estimate power consumption. The carrier frequency of the radio is assumed to be 300 GHz. The channel bandwidth of the wideband radio is assumed to be 25 GHz and the modulation type is 16-QAM. The sub-THz wideband radio design must be able to deliver a link distance of 10m or better and a data rate of 100 Gbps. The radio transceiver is assumed to employ a phased-antenna-array (PAA) transmitter and a PAA receiver (RX). The PAA transmitter (TX) employs a conventional IQ direct up-conversion architecture. Similarly, the PAA RX employs an IQ direct down-conversion receiver. The 300 GHz LO generator is assumed to employ a 75 GHz VCO/PLL and a 4× frequency multiplier consisting of a pair of 2× multipliers and an amplifier. The transceiver is assumed to operate in time division duplex (TDD) mode. Four TDD transceivers are used to feed a planar array consisting of 4 antenna elements. Each antenna element consists of 2 patch antennas. The planar array is used to feed and steer a hemispherical lens antenna. This may provide the best combination of antenna gain and steerability.

A sub-THz narrowband companion radio may be used to exchange control information between a network and a WTRU. It is assumed to employ an architecture similar to that shown in FIG. 6, with a difference being that the IQ receiver excludes the LNA. The channel bandwidth of the narrowband radio is assumed to be 20 MHz. The sub-THz narrowband radio design may be able to deliver a link distance of 75m or better. A near-constant-envelope modulation of 16-PSK is assumed for the narrowband radio to maximize link distance. The power consumption of the major components in both the wideband and narrowband radios is summarized in Table 2.

TABLE 2

| | Wideband Radio | | | Narrowband Radio | | |
|---|---|---|---|---|---|---|
| | OFDM/16QAM | | | CPM/16PSK | | |
| | Channel BW = 25 GHz | | | Channel BW = 20 MHz | | |
| | # | Total Power | | # | Total Power | |
| LNA | 4 | 230 | mW | — | — | |
| ADC | 8 | 2240 | mW | 8 | 31 | mW |
| Polar Decoder | 1 | 200 | mW | 1 | 2 | mW |
| PA | 4 | 810 | mW | 4 | 195 | mW |
| DAC | 8 | 1360 | mW | 8 | 20 | mW |
| LO Generator | 1 | 420 | mW | 1 | 420 | mW |

The power consumption of the wideband and narrowband transmitter and receiver are shown in Table-3. The narrowband transmitter delivers a 4.1× power reduction compared to the wideband transmitter. The narrowband receiver delivers a 6.8× power reduction compared to the wideband RX.

TABLE 3

| | Wideband | Narrowband | Power Reduction |
|---|---|---|---|
| | Radio | Radio | Factor |
| RX Mode Power | 3090 mW | 453 mW | 6.8x |
| TC Mode Power | 2590 mW | 635 mW | 4.1x |

For correct decoding of the received signals, that the network and devices connected to it should be in sync in both in time and frequency. In the receivers, small imperfections of the oscillators may pull the devices (e.g., WTRUs) out of sync, either in frequency or in time or both from the network. If a device drifts too far from the network, either in time or frequency, then decoding of the received signals may be difficult.

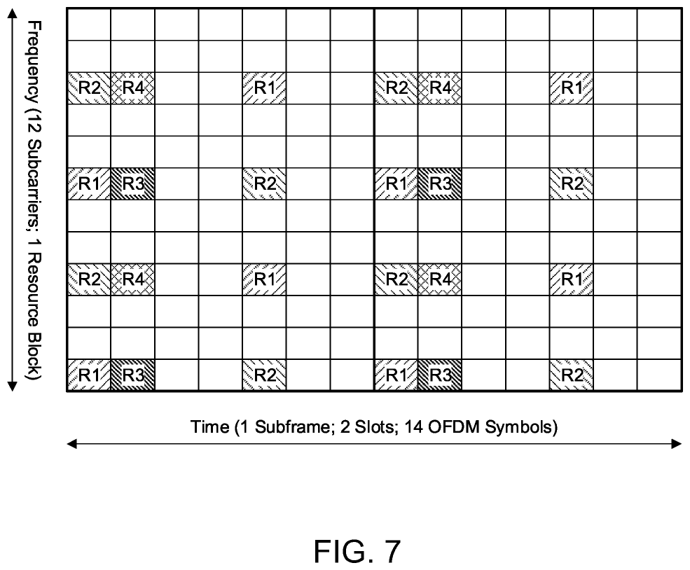

Signals may be used to aid oscillators of devices (e.g., WTRUs) in decoding a transmission. For example, in 3GPP LTE, eNBs may transmit Cell Specific Reference Signals (C-RS) which are transmitted in every subframe at specific locations in the resource element (RE) grid according to the number of antennas ports defined in the eNB. C-RS were defined for a maximum of 4 transmit antennas and Automatic Frequency Control (AFC) algorithms used to use these reference signals along with a Primary Synchronization Signal (PSS) to assist in frequency and timing synchronizations. FIG. 7 show the placement of C-RS in one Resource Block (RB) using two slots or one subframe, where R1, R2, R3 and R4 represent C-RSs for antenna ports 1, 2, 3 and 4 respectively.

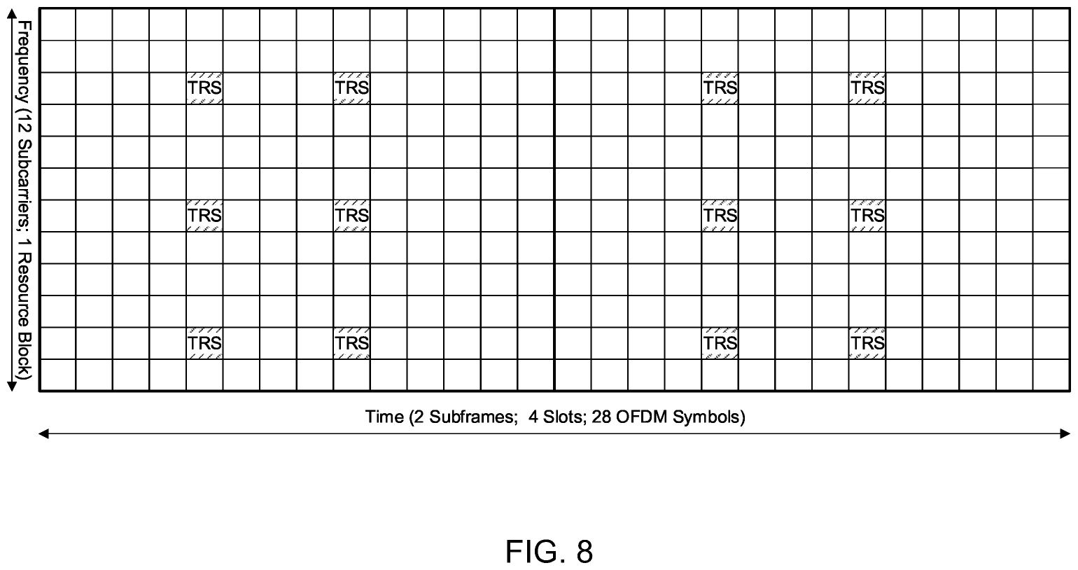

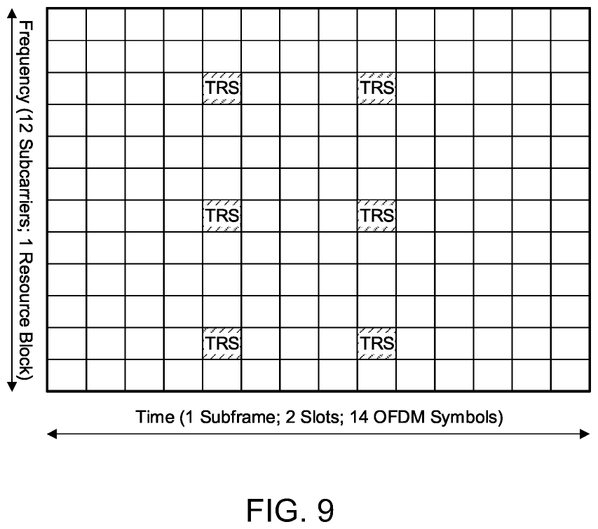

In 3GPP 5G New Radio (NR), a leaner approach reduced the always broadcast signals, so C-RS signals were discontinued. To assist the oscillators in the devices (WTRUs), Tracking Reference signals (TRS) were defined. TRS are basically CSI-RS signals which are transmitted on a regular basis with a particular periodicity (e.g. 10, 20, 40 or 80 milliseconds). There are different structures of TRSs. In a first structure, as shown in FIG. 8, if two adjacent slots are for downlink slots then TRSs may comprise four one port, density-3 CSI-RS signals located in two consecutive slots. The exact set of resources (REs and OFDM symbols) may vary for the TRS. In a second structure, as shown in FIG. 9, if two consecutive slots are not for downlink slots then TRSs may comprise two one port, density-3 CSI-RS signals located in one slot. The exact set of resources (REs and OFDM symbols) may vary.

In both TRS structures, there may be a four OFDM symbol time domain separation between the two CSI-RS within a slot, as shown in FIG. 8 and FIG. 9. This time domain separation sets the limit for the frequency error that can be tracked. Likewise, there is a separation of four subcarriers (REs) within a Resource Block (RB) and this will set the timing error that can be tracked, as shown in FIG. 8 and FIG. 9.

Since a TRS is a channel state information (CSI) Reference Signal, it may be across the entire bandwidth, or it may also be specified to be in part of the bandwidth by the network, and is unlike a DMRS signal which is only present in the resource blocks containing data (e.g. in a PDSCH).

If TRSs are periodic then it may take lot of overhead in the bandwidth of the cell. To reduce this overhead, a network may reduce the periodicity of these signals (e.g., 80 ms) or make these signals semi-persistent for some time by, for example, Downlink Control Information (DCI) signaling.

TRSs may be aperiodic. Aperiodic mode may be helpful in making the WTRU's to achieve faster synchronization in handover mode or secondary cell synchronization or when they come out of a long DRX cycle. Aperiodic mode may be left for gNB implementation, but the network may trigger aperiodic TRSs for the WTRUs in any of the above described scenarios to help a particular WTRU achieve faster synchronization. Aperiodic mode may be a WTRU specific mode.

Existing eMBB systems utilize a single wideband air-interface (WB-AI) for both control and data planes. Utilization of sub-THz wideband transceivers only for both control and data planes may be prohibitive in energy consumption and may not lend itself well to battery operated portable electronics. Due to elevated phase noise of sub-THz VCOs and poor drift characteristics of high frequency references, more frequent AFC updates may be required. Implementing an AFC using only the WB-AI may be energy prohibitive. In a WB-AI only approach, the periodic processing of sequences/messages either in the transmit or receive chains may result in low battery life. Furthermore, mobile sub-THz devices may be required to monitor control plane signals (e.g., frequency synchronization) more frequently due to, for example: (1) reduced frequency stability and higher drift of sub-THz local oscillators, compared to more familiar sub-6 GHz devices, and (2) elevated Doppler effects at higher frequency and highly directional deployment for a given WTRU velocity.

Frequent monitoring of control plane signals via a sub-THz wideband transceiver may significantly increase power consumption and may lead to a drastic reduction in the device battery life.

To improve device battery life, out-of-band (e.g. in sub-6 GHz frequency bands) companion air-interfaces are proposed. However, it is often desirable to deploy standalone single band and single radio access technology (RAT) operation. There may be several reasons for this. For example, an in-channel narrowband sub-THz companion air-interface (NB-CAI) may enable more accurate initial frequency error estimation in comparison to using an out-of-band sub-6 GHz transceiver. Consider a frequency error estimate of 200 Hz at 6 GHz. When applied to a phase-locked loop (PLL) loop at 300 GHz this results in 50×200=50 kHz of frequency error. Whereas the error may remain almost the same between the in-channel narrow band-companion air interface (NB-CAI) and wide band-air interface (WB-AI) PLL loops. Also, lower millimeter-wave (mmW) and sub-6 GHz frequency spectrum are at a premium and expected to be heavily occupied due to more favorable propagation characteristics and wide availability of low-cost devices as compared to sub-THz/THz bands. Therefore, there is a need to enable standalone single band and single RAT operation.

The use of in-channel NB-CAIs may have great potential to enable energy-efficient eMBB systems in a single band and single RAT deployment in the sub-THz frequency bands. It is desirable to keep the wideband transceiver (WB-TRX) in a sleep mode as often as possible and only activating it to transmit/receive data. Due to the lower power consumed by the narrowband companion transceiver (NB-TRX), it may be kept persistently active by the WTRU so that control plane information may be efficiently exchanged with the network.

To ensure energy efficiency of both the WTRU and gNB, there is a need to adaptively change the periodicity of WB-AFC related reference signals transmitted by the network based on a WTRU's WB PLL convergence status.

There is a need for the WTRU to efficiently measure and report sensory information (e.g. distance between a gNB and WTRU) to aid in the selection of reference signal parameters such as a WB-AFC related reference signal transmitted by the network matches the WB channel profile seen by the WTRU.

Since AFC loop settling time for a sub-THz WB TRX is known to be much longer than a sub-6 GHz transceiver, there may be a need to receive WB frequency convergence reference signals (FCRSs) in inactive state (i.e., micro-sleep, not deep-sleep) to reduce the time between DRX boundaries and the start of link establishment for WB data transmission by the WTRU.

During inter-transmit/receiver point (TRP) beam handover, where each TRP may have its own PLL reference, procedures are needed to handle a quasi-stationary WTRU frequency synchronization with the new TRP.

In the event of a highly mobile WTRU engaged in a beam handover procedure between TRPs, potential doppler shift occurring during the beam handover along with PLL reference offset, must be compensated to maintain link quality above a minimum threshold.

A wide-band air interface (WB-AI) WB TRX may be a primary wideband transceiver designed to transfer large amount of bursty or continuous data packets over a wide RF bandwidth while using highly directional RF beams to maintain a minimum link quality. WB Main TRX, WB Primary Air Interface, WB Air Interface, WB TRX, and WB-AI, may be used interchangeably herein.

A Narrow-Band Companion Air Interface (NB-CAI) NB-TRX may be a secondary narrowband transceiver designed to aid and assist the more power and resource intensive wideband primary transceiver in performing and monitoring mostly control plane signaling needed for events such as initial access, paging, and frequency synchronization. Existing NR reference signals may be used to generate NB-AFC frequency error estimates.

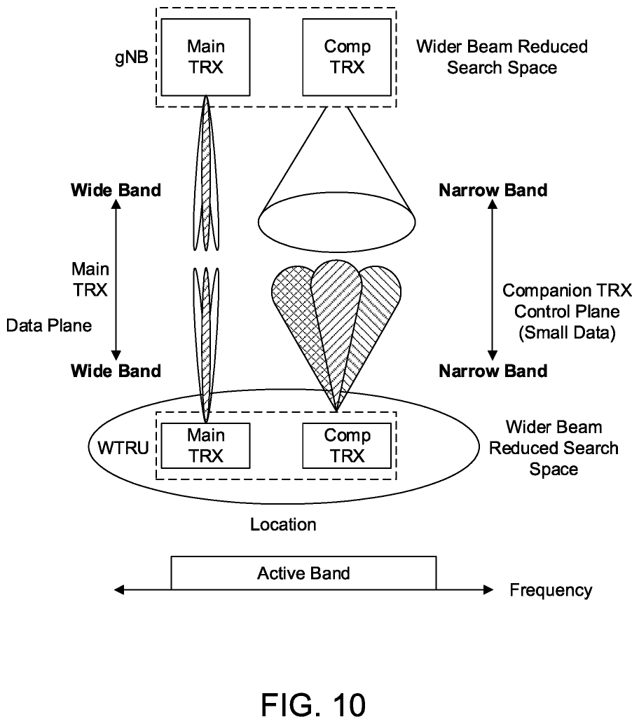

A communication system with two transceivers has been introduced to be operational at upper mmW and sub-THz/THz bands. A NB-CAI transceiver (TRX) and a wideband (WB) main TRX are shown in FIG. 10. The NB-CAI TRX is deployed over the same channel as the WB Main TRX (i.e., they coexist over the same spectrum).

NB-CAI, NB TRX, and NB-CAI TRX may be used interchangeably herein. Frequency error correction, and frequency error tracking may be used interchangeably herein.

Table-4 shows a design aspect of NB-CAI and WB TRXs. The NB-CAI TRX utilizes very narrowband with very high efficiency and larger power spectral density. The NB-CAI beamwidth is wider compared to the WB Main TRX such that the overlapping range becomes the same.

TABLE 4

| | gNB | | WTRU | |
|---|---|---|---|---|
| Highlights | NB-CAI TRX | WB Main TRX | NB-CAI TRX | WB Main TRX |
| Coverage | Overlaps with WB | Overlaps with NB- | Overlaps with WB | Overlaps with NB- |
| | Main TRX | CAI TRX | Main TRX | CAI TRX |
| Power budget | Sufficient | Sufficient | Limited | Limited |
| Number of | Sufficiently large | Sufficiently large | Limited | Limited |
| antenna | | | | |
| elements | | | | |
| beamwidth | Larger | Narrower | Larger | Narrower |
| Flexibility | Deployable in | Deployment to | Deployable in | Deployment to |
| | multiple frequency | cover the whole | multiple frequency | cover the whole |
| | raster within the | channel | raster within the | channel |
| | channel of interest | | channel of interest | |
| Control and | Control Plane | High throughput | Control Plane | High throughput |
| Data plane | mode with small | with ACK/NACK, | mode with small | with ACK/NACK, |
| | data enabled | limited | data enabled | limited |
| | | measurements | | measurements |
| | | support | | support |

It is assumed that the WTRU has a limited power budget whereas the gNB has a sufficient power budget.

A Frequency Convergence Reference Signal (FCRS) may not introduce any new elements (e.g. sequences) as compared to existing NR reference signals for AFC when used in a NB-CAI. However, the FCRS may introduce new wideband sequences used by the network for WB AFC procedures. This may be a control signal designed to indicate a sign of a rate of change of a frequency error between the gNB and the WTRU reference oscillators. If the error is being reduced, there may be a degree of convergence between the two references. If the error is increasing, there may be a degree of divergence. An FCRS indicator may be used by the WTRU to determine if a change in periodicity is needed to either speed up convergence or maintain an acceptable update rate.

A wideband automatic frequency correction (WB-AFC) may be an AFC technique used in wideband frequency synthesizers which may contain multiple voltage-controlled oscillators (VCOs) tuning curves to cover a wide range of radio frequencies.

A deep-sleep mode may be the lowest power consumption state of a transceiver. All elements of the transceiver except for a keep-alive clock may be de-activated. When a device is in deep-sleep mode, all elements of the transceiver power consumption may be reduced by de-activating its receiver and not monitoring/looking for paging signals or searching for service signals. A WTRU may occasionally or periodically enter a wake-up period where power consumption may be increased to perform signal searches in an assigned frequency band.

A micro-sleep mode may be the second lowest power consumption state of a transceiver. All elements of the transceiver, except the PLL, may be de-activated. A WTRU may also be defined as being in micro-sleep mode when at least one receiver component is temporarily de-activated for a portion of time, for example as a power saving measure.

In the embodiments and examples described herein, a network, network node, or network entity may refer to, but is not limited to, a gNB or a serving gNB. Although a particular network node (e.g. gNB or serving gNB) may be used in the embodiments and example described herein, it is understood that the embodiments and examples described herein may be applicable to other network nodes.

An exemplary embodiment describing a method to support in-channel NB-CAI assisted WB-TRX frequency error correction procedure may comprise at least one of the following actions: (1) a WTRU may send a FCRS Scheduling Request to a network entity (e.g. a gNB) via a NB-CAI with range information to initiate a frequency error correction procedure for a WB-AI; (2) the WTRU may receive a FCRS Scheduling Response comprising information such as FCRS sequence details, schedule information (e.g., periodicity, initial time offset), and frequency domain allocation from the gNB via a NB-CAI; (3) the WTRU may initialize (e.g. frequency offset) its WB-AI AFC loop with an estimated frequency offset error via NB-CAI reference signals; (4) activation of WB-AI triggering WB-AFC convergence procedure, WB FCRS sequences scheduled and activated; (5) the WTRU may receive FCRS transmissions on its WB-AI according to a schedule received on the NB-CAI; (6) the WTRU may request a reduction in the rate of FCRS transmissions by sending a FCRS Rate Reduction message via the NB-CAI upon detecting an AFC convergence indication and when the periodicity of the FCRSs in the current schedule is not at maximum; (7) the WTRU may receive an acknowledgement (ACK) with a new FCRS schedule from the gNB over its NB-CAI; (8) the WTRU may receive FCRS transmissions with a reduced rate (e.g. higher periodicity) from the gNB over the WB-AI, as requested; (9) the WTRU may request an increase in the rate of FCRS transmissions by sending a FCRS Rate Increase message via the NB-CAI upon detecting an AFC divergence indication and when the periodicity of the FCRSs in the current schedule is not at a minimum; (10) the WTRU may receive an ACK with a new FCRS schedule from the gNB over its NB-CAI; (11) the WTRU may receive FCRS transmissions with an increased rate (e.g., lower periodicity) from the gNB over the WB-AI, as requested; (12) when the WB TRX initiates a deactivation procedure, the WTRU may send a WB TRX deactivation request to the gNB via the NB-CAI and may switch back to the NB AFC loop upon receiving a confirmation from the gNB. The FCRS resources may then be released from the gNB and an ACK for the deactivation request may be sent via the NB-CAI to the WTRU.

The WTRU may send a FCRS Scheduling Request using a specific configured uplink (UL) sequence or sequences over the NB-CAI. The gNB may estimate the range from the received UL sequence. The WTRU may receive an FCRS configuration identifier (ID) in the FCRS Scheduling Response when the WTRU is pre-configured with the multiple available configurations for the FCRSs.

The WTRU may receive information of beam or beams (e.g., beam IDs or reference beam/beams associated with another NB-CAI or another WB-AI) in the FCRS Scheduling Response message from the gNB indicating which beam or beams may be used to transmit the FCRSs over the WB-AI by the gNB.

The WTRU may receive additional beam specific scheduling information, for example, a number of beams to be used for FCRS transmissions and scheduling of the FCRSs over beams, in the FCRS Scheduling Response or Update message from the gNB. The WTRU may determine a preferred FCRS configuration based on a convergence indication and an available set of FCRS configurations and send the preferred FCRS configuration ID to the gNB in a FCRS Rate Increase/Reduction Request message. The WTRU may send different indications (with different combination of bits) in the FCRS Rate Increase/Reduction Request to request different rates/levels of change in the FCRS periodicity.

An FCRS periodicity rate of change, which may be initialized at zero, may be allowed to follow a linear function until a convergence indication is detected. The FCRS periodicity rate of change may be allowed to follow a non-linear function (e.g., square or exponential) until a convergence indication is detected, to speed-up convergence, particularly when starting from a large initial frequency error value.

The WTRU may average several frequency error measurements to filter or reduce variations due to VCO noise and arrive at more stable FCRS updates. The number of frequency error measurements taken to compute that average should not exceed a maximum count to keep the latency in FCRS updates below a predetermined threshold.

The WTRU may send a Range Update message via a NB-CAI when the change in the WTRU range is above a threshold indicating an increment or a decrement in the range.

The WTRU may send different indications, with different combination of bits, in the Range Update message to indicate different levels of change in the WTRU range.

The WTRU may determine a preferred FCRS configuration based on the derived range and an available set of configurations for the FCRSs and may send the preferred FCRS configuration ID to the gNB in the Range Update message.

The WTRU may receive an ACK from the gNB via a NB-CAI indicating the requested FCRS configuration is accepted or granted.

The WTRU may receive a DL response from the gNB via a NB-CAI with the information of new FCRS configuration or sequence granted or selected by the gNB.

The WTRU may receive the FCRSs over a WB-AI according to a newly granted or selected configuration or sequence information received over the NB-CAI.

A method to support in-channel NB-CAI assisted WB frequency correction procedure may be triggered by the gNB.

The WTRU may receive a FCRS Scheduling Update message from the gNB comprising information such as FCRS sequence details, schedule information (e.g., periodicity, initial time offset), and frequency domain allocation via the NB-CAI.

The WTRU may receive the FCRS configuration ID in the FCRS Scheduling Update message when the WTRU is pre-configured with multiple available configurations for the FCRSs

The WTRU may terminate the AFC loop for the WB-AI after receiving a WB TRX deactivation message from the gNB.

An exemplary embodiment describing a method to support an in-channel NB-CAI assisted WB-AI frequency correction procedure during a WB-TRX's inactive state may comprise at least one of the following actions: (1) a WTRU may receive a configuration of FCRS transmissions via a NB-CAI from a network entity (e.g. gNB) to perform frequency correction procedure during a WB-TRX's inactive state; (2) the WTRU may send an ACK via the NB-CAI to the gNB confirming the FCRS configuration; (3) during the WB-TRX's inactive state, the WTRU may transition from a deep sleep to a micro-sleep mode for the WB-TRX in every or some DRX cycles to receive the FCRSs according to the given FCRS scheduling configuration and may perform measurements for the frequency correction procedure; (4) the WTRU may request a reduction in a rate of FCRS transmissions by sending a FCRS Rate Reduction message via the NB-CAI upon detecting an AFC convergence indication and when a periodicity of the FCRSs in the current schedule is not at a maximum; (5) the WTRU may receive an ACK with a new FCRS schedule from the gNB over its NB-CAI; (6) the WTRU may wake-up (e.g. activating micro-sleep mode for the WB-TRX) in every or some DRX cycles to receive FCRS transmissions with a reduced rate from gNB over the WB-AI; (7) the WTRU may request an increase in the rate of FCRS transmissions by sending a FCRS Rate Increase message via the NB-CAI upon detecting an AFC divergence indication and when the periodicity of the FCRSs in the current schedule is not at a minimum; (8) the WTRU may receive an ACK with a new FCRS schedule from the gNB over its NB-CAI; and (9) the WTRU may wake-up (e.g. activating micro-sleep mode for the WB-TRX) in every or some DRX cycles to receive FCRS transmissions with an increased rate from the gNB over the WB-AI.

The WTRU may, after receiving the configuration of FCRS transmissions via the NB-CAI from the gNB, send a NACK via the NB-CAI indicating that the WTRU determines to not perform the frequency error correction procedure during the WB-TRX's inactive state.

After receiving a configuration of DL FCRS transmissions via the NB-CAI from the gNB, the WTRU may send a request via the NB-CAI requesting or indicating a different preferred FCRS configuration.

The WTRU may monitor for an ACK from the gNB after sending a different preferred FCRS configuration to the gNB.

The WTRU may receive information such as the beam or beams (e.g., beam IDs or reference beam/beams associated with another NB-CAI or another WB-AI), a number of beams to be used for FCRSs transmissions, and scheduling of the FCRSs over beams as a part of the FCRS configuration from the gNB.

The WTRU may determine a preferred FCRS configuration based on a convergence indication and an available set of FCRS configurations and may send a preferred FCRS configuration ID to the gNB in the FCRS Rate Increase/Reduction Request message.

The WTRU may send different indications, with different combination of bits, in the FCRS Rate Increase/Reduction Request to request different rates/levels of change in the FCRS periodicity.

An exemplary embodiment describing a method to support in-channel NB-CAI assisted WB-AI frequency correction procedure in the case of WB-AI beam switch may comprise at least one of the following actions: (1) a WTRU may receive an indication for a new WB-AI DL beam from a network entity (e.g., gNB) via a NB-CAI, indicating whether the new beam (e.g., used after the beam switch) is quasi co-located (QCL) with a previous beam (e.g., used before the beam switch) with respect to the parameters related to frequency offset error estimation; (2) the WTRU may send an ACK via the NB-CAI to the gNB confirming that the same FCRS configuration which was used over the previous beam may be used for the new beam; (3) the WTRU may receive the WB-AI FCRSs on the new beam using the same FCRS configuration that the WTRU was using over the previous beam.

The WTRU may send a request to the gNB over a NB-CAI to configure FCRS transmissions with a high rate of transmissions after receiving a QCL indication between the new beam and the previous beam (e.g., with respect to the parameters related to frequency offset error estimation) for example in high mobility or Doppler-shift scenarios.

The WTRU may receive the new FCRS configuration for the new beam over a NB-CAI after sending the request to the gNB to configure a higher rate of FCRS transmissions.

The WTRU may send a request via the NB-CAI indicating a different preferred FCRS configuration

The WTRU may monitor for an ACK from the gNB after sending a different preferred FCRS configuration to the gNB.

A WTRU may perform a frequency error correction (e.g., between a serving gNB or gNB oscillator or reference clock and the WTRU oscillator or reference clock) procedure (e.g., AFC) for a WB-AI using assistance from a NB-CAI. The WTRU may use a frequency offset estimate of the NB-CAI as an initial frequency error for the WB-AI. The WTRU may use the NB-CAI to transmit and/or receive some or all the control information required to perform the frequency error correction procedure for the WB-AI. The WTRU may use the NB-CAI to transmit and/or receive some or all the control information required to optimize the frequency error correction procedure performed at the WB-AI.

The WTRU may perform a frequency error correction procedure at a NB-CAI. A gNB may schedule one or more periodic DL reference signals/sequences at the NB-CAI. The WTRU may use one or more periodic DL reference signals/sequences received at the NB-CAI to estimate a frequency offset between the gNB clock and the WTRU clock for the NB-CAI. The configuration of the periodic DL reference signals/sequences (e.g. time schedule including periodicity, frequency domain location, sequence generation method along with identifiers need to be used to generate the sequences, etc.) may be provided to the WTRU, for example, via system information or as a part of the higher layer signaling. The estimated frequency offset for the NB-CAI may be used as a coarse local oscillator frequency error (e.g., as an initial frequency error estimate) for the WB-AI for which the frequency error correction procedure needs to be performed or initiated.

The WTRU may use a NB-CAI to transmit and/or receive some or all the control information required to perform frequency error correction procedure for a WB-AI. In an embodiment, when the WTRU determines to initiate the frequency error correction procedure for a WB-AI (e.g., after the activation of the WB-AI), the WTRU may request to the gNB to initiate the frequency error correction procedure for the WB-AI. In an embodiment, when the gNB determines to activate a WB-AI, the gNB may send a DL message/command to the WTRU (e.g., over a NB-CAI) to initiate the frequency error correction procedure for the WB-AI.

In order to initiate the frequency error correction procedure for a WB-AI, the WTRU may send a request to the gNB to schedule DL reference signals/sequences which may be used to estimate the frequency error at the WB-AI. Specific reference signal/sequences may be defined for this purpose (e.g., Frequency Convergence Reference Signals (FCRS)). Alternatively or in addition, reference signals/sequences which are used for other purposes, (e.g., synchronization (e.g., PSS, SSS), channel estimation (e.g., CSI-RS), demodulation (e.g., DM-RS), positioning (e.g., PRS), phase tracking (e.g., PT-RS), etc.), may be used as a FCRS for the purpose of frequency error correction.

The WTRU may send a request (e.g., FCRS Scheduling Request) to the gNB to schedule FCRSs for the WB-AI. The FCRS Scheduling Request may be sent over a NB-CAI. In an example, the FCRS Scheduling Request may comprise a WTRU range (e.g., a line of sight distance of the WTRU from the gNB). The WTRU may determine the range, for example, using the NB DL synchronization sequence transmitted (e.g., over the NB-CAI) by the gNB. The gNB may transmit the NB DL synchronization sequences (e.g., over the NB-CAI) periodically. The WTRU may detect the periodic NB DL synchronization sequences (e.g., over the NB-CAI) and may derive and/or update the WTRU's range. The information of NB DL synchronization sequences, for example, which sequences will be used (e.g. sequence generation method along with IDs to be used to generate the sequences, etc.), period, slot/symbol/frame numbers, frequency domain location, etc., may be communicated to the WTRU.

In an example, the WTRU may send the FCRS Scheduling Request (e.g., over the NB-CAI) using specific UL sequences (e.g., UL NB sequences). The WTRU may be configured with sequences (e.g., UL NB sequences dedicated for the purpose to send a FCRS Scheduling Request). A dedicated (e.g., WTRU-specific) or a common pool of sequences for all the WTRUs for the purpose of sending a FCRS Scheduling Request may be configured. If a common pool of sequences for all the WTRUs is configured, a WTRU may select (e.g., randomly) a sequence from the configured sequences. After receiving/detecting a FCRS Scheduling Request specific sequence from the WTRU, the gNB may estimate the range of the WTRU based on the detection on the FCRS Scheduling Request specific sequence.

In an example, the WTRU may send the FCRS Scheduling Request (e.g., message with range information or specific UL sequence) using a next available UL resource over the NB-CAI. The configuration of UL/DL resources (e.g., timing information) may be communicated to the WTRU. In an example, the WTRU may be configured with dedicated periodic UL resources (e.g., using the UL control or shared channel) over the NB-CAI to send FCRS Scheduling Requests. Upon determining to use frequency error correction for a WB-AI, the WTRU may send the FCRS Scheduling Request using the next available dedicated periodic UL resource allocated for FCRS Scheduling Requests. In an example, the WTRU may send a request (e.g., using an UL control channel) to the gNB over the NB-CAI to grant UL resources (e.g., over an UL control or shared channel) for the UL FCRS Scheduling Request. The WTRU may send the FCRS Scheduling Request using the granted UL resources. The FCRS Scheduling Request may be sent, for example, as an UL MAC-CE or as a higher layer signaling message (e.g., UL RRC message).

After sending a FCRS Scheduling Request over the NB-CAI, the WTRU may monitor for a DL response (e.g., FCRS Scheduling Response) from the gNB over the NB-CAI. The FCRS Scheduling Response may be received over a DL control channel (e.g. as downlink control information (DCI)) or over a DL shared channel (e.g., as a MAC-CE message, a DL RRC message, etc.). In an example, a maximum retransmission duration/window (e.g., FCRS Scheduling Request retransmission duration) may be configured to the WTRU. The WTRU may re-send the FCRS Scheduling Request (e.g., at a later time) to the gNB, for example when after sending a FCRS Scheduling Request, the WTRU does not receive a FCRS Scheduling Response from the gNB within the FCRS Scheduling Request retransmission duration.

In an example, when the gNB determines to activate a WB-AI, the gNB may send a DL message/command (e.g., FCRS Scheduling Update) to the WTRU (e.g., over a NB-CAI) to initiate the frequency error correction procedure for the WB-AI.

The FCRS Scheduling Response/Update message may comprise the parameters for the FCRSs to be scheduled over the WB-AI by a gNB to enable the frequency error correction procedure at the WB-AI, which may include, at least one or more of the following parameters: (1) FCRS sequence or sequence generation parameters (e.g., identifiers to be used to generate the sequence): the gNB may select one or more wideband sequences by using the range information (e.g., received or detected from the WTRU's FCRS Scheduling Request), carrier frequency, and transparency window related information (e.g., environmental factors such as humidity, dust, and molecular structure of the air); (2) periodicity (e.g., in terms of number of symbols/slots/sub-frames/frames); (3) initial offset (e.g., in terms of number of symbols/slots/sub-frames/frames); (4) starting symbol/slot/sub-frame/frame and number of symbols/slots/sub-frames/frames or symbol/slot/sub-frame/frame numbers/indices in case of non-consecutive allocation; (5) bandwidth span (e.g., in terms of number of sub-carriers/resource elements/resource blocks); (6) density which may be in terms of number of resource blocks, may be over a given bandwidth, or may include a number of resource elements per resource block, and/or may be indicated as one of the patterns where a set of patterns (e.g., a set of defined patterns of different frequency allocations) may be communicated to the WTRU (e.g., using system information or higher layer signaling).

The periodicity (e.g., initial value of the periodicity) of FCRS transmissions may be derived based on a WTRU capability, for example, the WTRU's VCO quality for the WB-AI. The WTRU may report its VCO quality to the gNB. For example, the WTRU may report its VCO quality in the FCRS Scheduling Request sent using the NB-CAI.

In an embodiment, the WTRU may be pre-configured with multiple different configurations for the FCRS scheduling (e.g., a set of FCRS scheduling configurations, where each FCRS scheduling configuration may include the value of one or more of: FCRS sequence or sequence generation parameters, periodicity, initial offset, starting symbol/slot/sub-frame/frame with number of symbol/slot/sub-frame/frame or symbol/slot/sub-frame/frame numbers/indices in case of non-consecutive allocation, bandwidth span, density, etc.). Each FCRS scheduling configuration in the set of FCRS scheduling configurations may have a different value for at least one of the parameters compared to all other configurations in the set. Each FCRS scheduling configuration may have an identifier (e.g., configuration ID). The set of FCRS scheduling configurations may be communicated to the WTRU by the gNB, for example, via system information or higher layer signaling. In this case, the FCRS Scheduling Response/Update message may include the configuration ID associated with the FCRS scheduling configuration to be activated.

After receiving the FCRS Scheduling Response/Update message from the gNB, the WTRU may initiate a frequency error correction procedure (e.g. AFC convergence procedure) for the associated WB-AI (e.g., for which the FCRS scheduling is requested and received) according to FCRS schedule information received in the FCRS Scheduling Response/Update message. The WTRU may receive the FCRSs on the WB-AI according to the schedule information provided in FCRS Scheduling Response/Update message and may use them in the AFC loop to correct the frequency error. At each period of FCRS reception (e.g., at each reception of a FCRS burst), the WTRU may perform the correlation with the received FCRSs and may use the correlator output to estimate the frequency error. The WTRU may initialize the AFC loop with an estimated frequency offset at a NB-CAI.

The WTRU may receive FCRSs over one or more beams using a WB-AI. One or more beams of a WB-AI may be associated with a NB-CAI beam. For example, the WTRU may determine one or more beams to receive the FCRSs over a WB-AI which are associated with a beam of a NB-CAI used to receive control information to schedule FCRSs (e.g., FCRS Scheduling Response or FCRS Scheduling Update). In an example, the information of beam or beams to be used to transmit the FCRSs over the WB-AI (e.g., beam IDs or reference beam/beams associated with another NB-CAI or another WB-AI) may be communicated to the WTRU in, for example, a FCRS Scheduling Response or Update message. The WTRU may determine corresponding/associated receive beam/beams to receive the FCRSs over the WB-AI. In an example, the WTRU may indicate its preference for the beam/beams (e.g., gNB Tx beams) to be used for FCRS transmissions over the WB-AI in for example, the FCRS Scheduling Request message.

In case of transmission of FCRSs over multiple WB-AI beams, the additional scheduling information, for example, number of beams to be used for FCRSs transmissions, and scheduling of the FCRSs over beams, may be provided to the WTRU in for example, a FCRS Scheduling Response or Update message.

In an example, the WTRU may use FCRSs received using a best receive beam (e.g., highest RSRP) for the frequency error correction procedure. In an example, the WTRU may use FCRSs received using the multiple receive beams and may perform measurements (e.g. average measurements) over the multiple beams for the frequency error correction procedure.

The WTRU may use FCRSs to measure the reduction or rate of reduction in frequency error between two oscillators (e.g., between gNB's and WTRU's oscillators) or reference clocks (e.g., between gNB's and WTRU's reference clocks). An indicator (e.g., convergence indicator) may be defined, where a value of the convergence indicator may be defined as inversely proportional to a magnitude of the frequency error between, for example, the gNB's and WTRU's reference clocks. When the magnitude of the frequency error between, for example, the gNB's and WTRU's reference clocks, decreases, or reaches to a low value (e.g., minimum value or a zero value), the convergence indicator may be assigned a large value. Conversely, as the magnitude of the frequency error (e.g., between the gNB's and WTRU's reference clocks) increases, the convergence indicator may be assigned a low value.

During the frequency error correction procedure at the WB-AI, the WTRU may request to update the FCRS scheduling configuration (e.g., periodicity), for example, based on a value of the convergence indicator. For example, if the value of the convergence indicator becomes higher than a predefined threshold (e.g., convergence threshold), the WTRU may request to decrease the FCRSs or decrease the rate of FCRS transmissions (e.g., increase the value of the periodicity of the FCRS transmissions) and/or decrease the number of FCRS transmissions (e.g., in the time domain) in a period or instance (e.g. each period or instance) of transmission. The WTRU may request to decrease the rate of FCRS transmissions as a power saving measure. The WTRU may request to decrease the rate of FCRS transmissions (e.g., increase the value of the periodicity) if the current configured/activated/used periodicity is not a maximum periodicity, if the maximum periodicity is known at the WTRU.

In an example, if the value of the convergence indicator falls below a predefined threshold (e.g., divergence threshold), the WTRU may request to increase the FCRSs or increase the rate of FCRS transmissions (e.g., decrease the value of the periodicity of the FCRS transmissions) and/or increase the number of FCRS transmissions (e.g., in the time domain) in every period or instance of transmission. The WTRU may request to increase the rate of FCRS transmissions to expedite the convergence procedure. The WTRU may request to increase the rate of FCRS transmissions (e.g., decrease the value of the periodicity) if the current configured/activated/used periodicity is not a minimum periodicity, if the minimum is known at the WTRU).

The value of a threshold (e.g., convergence and/or divergence threshold) may be configured by the gNB via, for example, system information or higher layer signaling.

The WTRU may request to decrease the rate of FCRS transmissions (e.g., increase the value of the periodicity) by sending a request (e.g., FCRS Rate Reduction Request) to the gNB. The WTRU may send the request via a NB-CAI. The WTRU may request to increase the rate of FCRS transmissions (e.g., decrease the value of the periodicity) by sending a request (e.g., FCRS Rate Increase Request) to the gNB. The WTRU may send the request via a NB-CAI.

In an example, in high-mobility scenarios where FCRS convergence indications are quickly followed by divergence indications, indicating a high-mobility environment or doppler-shift, the WTRU may request to maintain a higher rate of FCRS transmissions throughout the periodicity ramp-up/down cycles, until convergence reverts to a stable level for a predetermined duration. As a result, frequency error correction may be more responsive precisely when more accurate and timely estimates are needed at a cost of a temporarily increase in power consumption. Once FCRS convergence indication remains within a pre-assigned/pre-configured range, for a predetermined period, normal decrease or ramping-down in periodicity rate may resume.

In an example, the request to increase or decrease the rate of FCRS transmissions (e.g., FCRS Rate Increase Request/FCRS Rate Reduction Request) may comprise a flag or indicator (e.g., value ‘1’ for increase or value ‘0’ for decrease). The rate of change of the FCRS periodicity may follow a linear function until a predetermined convergence value is achieved. Alternatively, the rate of change of the FCRS periodicity may follow a non-linear law (e.g., square or exponential), for faster convergence, particularly for large initial frequency error starting values.

In an example, multiple thresholds for the convergence indicator may be configured to the WTRU to determine the different rates of requirements for the FCRS transmissions. In this case, a multi-bit (e.g., multi-level) flag may be used at the WTRU to indicate the different rates of change of the FCRS periodicity. For example, in case of four different thresholds (e.g., threshold 1, threshold 2, threshold 3, and threshold 4) and a two-bit flag for indication may be configured. If the convergence indicator falls below a threshold1, the WTRU may request to increase the rate of FCRS transmission by a factor of 2 by using, for example, flag ‘00’. If the convergence indicator falls below a threshold2 (<threshold1), the WTRU may request to increase the rate of FCRS transmission by a factor of 3 by using, for example flag ‘01’. If the convergence indicator goes above a threshold3 (>threshold1), the WTRU may request to decrease the rate of FCRS transmission by a factor of 2 by using, for example, flag ‘10’. If the convergence indicator goes above a threshold4 (>threshold2), the WTRU may request to decrease the rate of FCRS transmission by a factor of 3 by using, for example flag ‘11’. More thresholds and a greater number of bits for the flag indication may be used.

In an example, the WTRU may include a preferred FCRS configuration (e.g., configuration ID) in a request, for example, when the WTRU is configured with multiple FCRS configurations (e.g., a set of FCRS configurations). The WTRU may determine the preferred FCRS configuration based on the convergence indicator and the available set of configurations (e.g., with different periodicity of FCRS transmissions). In an example, a threshold (e.g., first threshold) may be configured to the WTRU. For example, when the convergence indicator falls below the first threshold, the WTRU may select a FCRS configuration with a higher rate of FCRS transmissions compared to the current FCRS configuration. Another threshold (e.g., second threshold) may be configured to the WTRU for indicating the convergence, for example, when the convergence indicator goes above the second threshold, the WTRU may select a FCRS configuration with a lower rate of FCRS transmissions compared to the current FCRS configuration. Multiple thresholds for the convergence indicator may be configured to the WTRU to determine the different rates of requirements for the FCRS transmissions. For example, in case of four different thresholds (e.g., threshold 1, threshold 2, threshold 3, and threshold 4), if the convergence indicator falls below a threshold1, the WTRU may select a FCRS configuration having rate of FCRS transmissions higher by at least a factor 2. If the convergence indicator falls below a threshold 2 (<threshold1), the WTRU may select a FCRS configuration having rate of FCRS transmissions higher by at least a factor 3. If the convergence indicator goes above a threshold3 (>threshold1), the WTRU may select a FCRS configuration having rate of FCRS transmissions lower by at least a factor 2. If the convergence indicator goes above a threshold4 (>threshold2), the WTRU may select a FCRS configuration having rate of FCRS transmissions lower by at least a factor 3, and so on with more thresholds and a greater number of bits for the flag indication.

In an example, the WTRU may include the value of the convergence indicator in the request to increase or decrease the rate of FCRS transmissions.

A request to increase or decrease the rate of FCRS transmissions (e.g., FCRS Rate Increase Request/FCRS Rate Reduction Request) may be transmitted using specific UL messages (e.g., a MAC-CE, UL control information, higher layer signaling, or specific UL sequences). In an example, the WTRU may send a request using the next available UL resource. The configuration of UL/DL resources (e.g., timing information) may communicated to the WTRU. In an example, the WTRU may be configured with dedicated periodic UL resources (e.g., using an UL control or shared channel) over the NB-CAI to send the request to increase or decrease the rate of FCRS transmissions. Upon determining the need to increase or decrease the rate of FCRS transmissions, the WTRU may send a FCRS Rate Increase Request/FCRS Rate Reduction Request using the next available dedicated periodic UL resource (e.g., using an UL control or shared channel). In an example, the WTRU may send a request (e.g., using an UL control channel) to a gNB over the NB-CAI to grant UL resources (e.g., over an UL control or shared channel) for the FCRS Rate Reduction Request/FCRS Rate Increase Request. The WTRU may send the FCRS Rate Reduction Request/FCRS Rate Increase Request using the granted UL resources. In an example, specific UL sequences may be used to transmit the request. One or more UL sequences may be configured by the gNB, for example, one sequence to indicate the request to increase the rate of FCRS transmissions and another sequence to indicate the request to decrease the rate of FCRS transmissions. Multiple UL sequences may be configured in case of multi-level indications (e.g., to enable indications for different rate of increase and/or decrease).

After sending a request to increase or decrease the rate of FCRS transmissions (e.g., FCRS Rate Increase Request/FCRS Rate Reduction Request) over a NB-CAI, the WTRU may monitor for a DL response from the gNB over the NB-CAI. The DL Response may be received over a DL control channel (e.g. as a DL control information) or over a DL shared channel (e.g., as a MAC-CE message or as a DL RRC message). The DL response may comprise an acknowledgement (ACK) (e.g., FCRS Rate Reduction ACK/FCRS Rate Increase ACK) indicating the request to change the FCRS configuration is accepted by the gNB, or a negative or non-acknowledgment (NACK) indicating that the request to change the FCRS configuration is not accepted by the gNB. In an example, the DL response from the gNB may comprise a configuration ID (e.g., if a set of configurations are pre-configured to the WTRU) or parameters (e.g., periodicity, initial offset, starting symbol/slot/sub-frame/frame, number or indices of symbols/slots/sub-frames/frames, density, bandwidth span, or FCRS sequence related parameters, etc.) associated with the granted (e.g., newly granted or allocated or updated) FCRS configuration based on the WTRU request.

The WTRU may be configured with a maximum time offset or window for monitoring for reception of a DL response after sending a request to increase or decrease the rate of FCRS transmissions. If the WTRU does not receive a response from the gNB within a configured maximum window/time offset, the WTRU may send another request (e.g., at a later time). The configuration of the maximum time offset or window (e.g., in terms of symbols/slots/sub-frame/frames or an absolute time value) may be communicated to the WTRU (e.g., in system information or as a part of the higher layer signaling).

If a response comprising an ACK or a granted (e.g., newly granted/updated/accepted) configuration is received by the WTRU, the WTRU may be configured with a time offset (e.g., in terms of symbols/slots/sub-frame/frames or in terms of absolute time unit) to determine when the new (e.g., newly granted/updated/accepted) configuration becomes active after receiving the response. The configuration of the time offset may be communicated to the WTRU, for example in the response containing the ACK or granted configuration, as a part of the higher layer signaling (e.g., RRC signaling), or in system information.

The WTRU may receive the FCRSs (e.g., using the WB-AI) configured as per the DL response message and may perform measurements for the frequency error correction procedure.

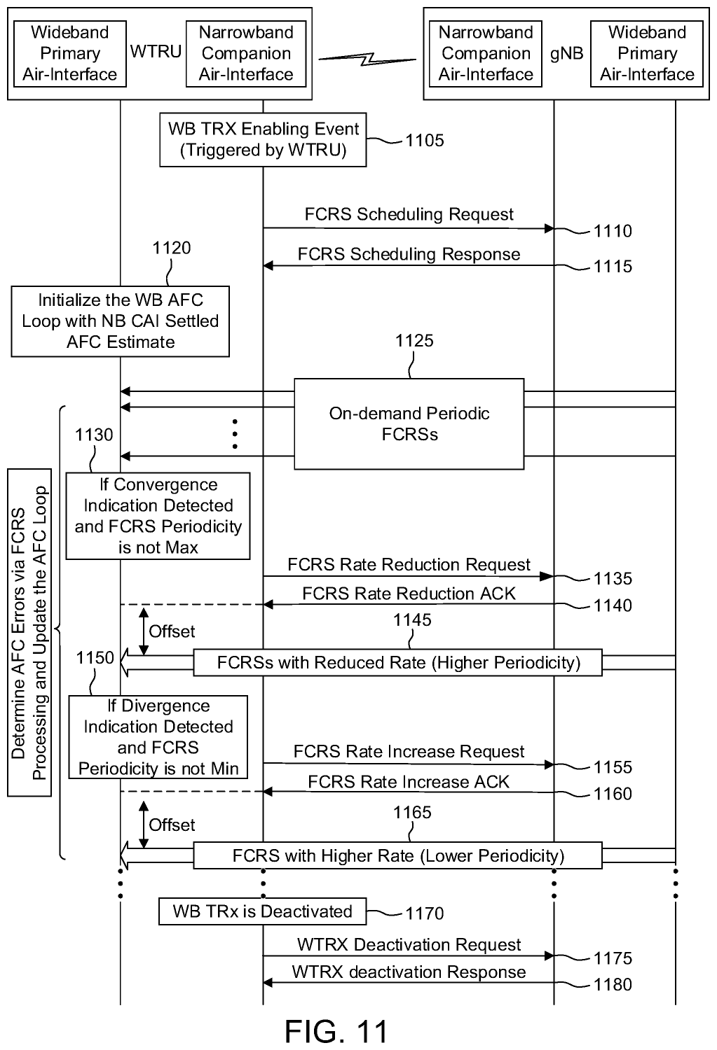

In an embodiment, a frequency error correction procedure for a WB-AI is shown in FIG. 11. A WTRU may have a WB-AI for which a frequency error correction procedure should be performed and may use a NB-AI for assistance. A WB transmission enabling event may occur (1105). The WB transmission enabling event may be that the WTRU has (e.g. in a buffer) a large amount of data to transmit. The event may be triggered by the WTRU. The WTRU may activate a WB-AI in response to the event. After the activation of the WB-AI, the WTRU may initiate a frequency error correction procedure (e.g. AFC) by sending a scheduling request to a gNB. The scheduling request may be a frequency convergence reference signal (FCRS) Scheduling Request message. The scheduling request may comprise range information. The range information may indicate a physical distance between the WTRU and the gNB. The range information may be sent explicitly (e.g. the physical distance between the WTRU and gNB). The range information may be sent implicitly (e.g. a value of a timing advance). The scheduling request may be sent via the NB-CAI. The WTRU may receive a scheduling response from the gNB (1115). The scheduling response may be a FCRS Scheduling Response message. The scheduling response may be received via the NB-CAI. The scheduling response may comprise schedule information. The schedule information may comprise at least one of: FCRS sequence information, periodicity, initial time offset, frequency domain allocation information; and beam information. After receiving the scheduling response from the gNB, the WTRU may initialize an AFC loop of the WB-AI (1120). The WTRU may use an estimated frequency offset available for the NB-CAI. The WTRU may start receiving periodic FCRSs (e.g., WB FCRSs) over the WB-AI according to the schedule information in the FCRS Scheduling Response message (1125). The WTRU may perform measurements on the received FCRSs. The WTRU may check for a convergence or divergence indication. If a convergence indication is detected during the frequency error correction procedure at the WB-AI and the periodicity of the FCRS transmissions are not at a maximum (1130), the WTRU may send a rate reduction request to the gNB (1135). The rate reduction request may be a FCRS Rate Reduction Request message. The rate reduction request may be sent via the NB-CAI. The WTRU may receive an acknowledgment (ACK) message from the gNB (1140). The ACK may be a FCRS rate reduction ACK message. If the WTRU receives the FCRS rate reduction ACK message from the gNB, the WTRU may apply the new FCRS configuration with a reduced rate (e.g., with a higher periodicity) after a configured offset (1145). If a divergence indication is detected during the frequency error correction procedure at the WB-AI and the periodicity of the FCRS transmissions are not at a minimum (1150), the WTRU may send a rate increase request to the gNB (1155). The rate increase request may be a FCRS Rate Increase Request message. The rate increase request may be sent via the NB-CAI. The WTRU may receive an ACK message from the gNB (1160). The ACK may be a FCRS rate increase ACK message. If the WTRU receive the FCRS rate increase ACK message, the WTRU may apply the new FCRS configuration with an increased rate (e.g. with a lower periodicity) after a configured offset (1165). The WTRU may determine to deactivate the WB TRX (1170). The WTRU may send a WB TRX deactivation request message to the gNB to terminate the AFC loop (1175). The gNB may send a WB TRX deactivation response message to the WTRU (1180). The WTRU may release the FCRS resources.

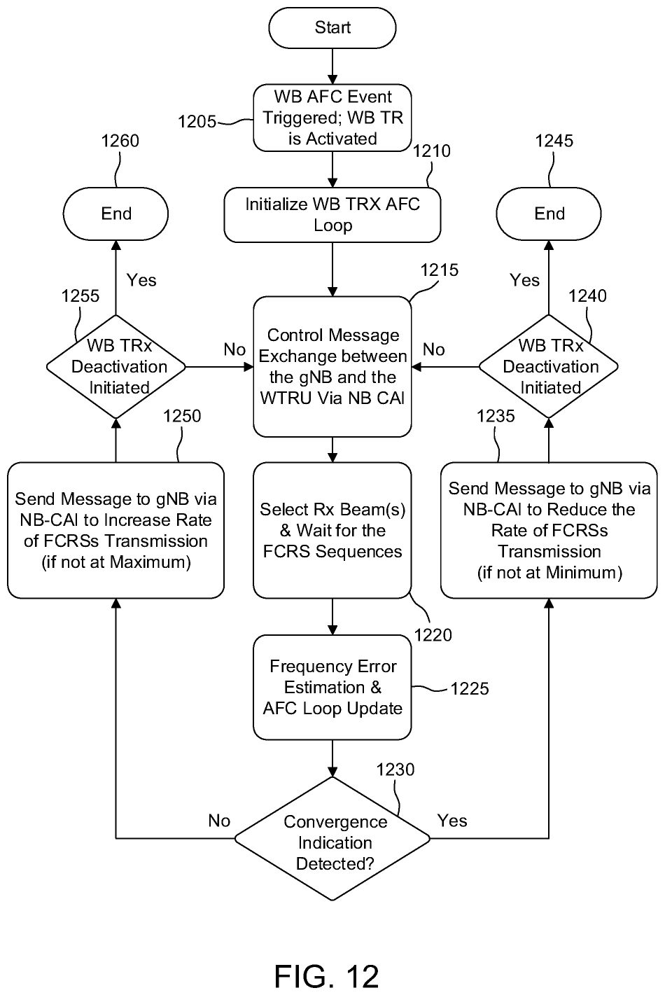

FIG. 12 shows an example of a method by a WTRU for performing a frequency error correction procedure with dynamic update of FCRS periodicities. A WTRU may activate a WB TRX in response to a WB AFC trigger (1205). The WTRU may initialize a WB TRX frequency error correction (e.g. AFC) loop (1210). The WTRU may use an estimated frequency offset available for the NB-CAI. The WTRU may send and/or receive one or more control message with a gNB via a NB-CAI (1215). The control message(s) may comprise any of a FCRS scheduling request message from the WTRU which may comprise range information, a schedule response from the gNB which may be at least one of: FCRS sequence information, periodicity, initial time offset, frequency domain allocation information; and beam information. The WTRU may select one or more receive beams and then wait for the FCRS sequences from the gNB (1220). The WTRU may perform frequency error estimation and start the AFC loop update (1225).

The WTRU may determine whether a convergence indication is detected (1230). If a convergence indication is detected, the WTRU may send a rate reduction message to the gNB to reduce the rate of FCRS transmission to save energy, if the periodicity of the FCRS transmission is not at a minimum (1235). The rate reduction message may be sent via the NB-CAI. The WTRU may determine whether to deactivate the WB TRX (1240). If the WTRU determines not to deactivate the WB TRX, the WTRU may continue the procedure and may send and/or receive control message with the gNB (1215). If the WTRU determines to deactivate the WB TRX, the WTRU may deactivate the WB TRX and stop the procedure (1245).

If a convergence indication is not detected or a divergence indication is detected, the WTRU may send a rate increase message to the gNB to increase the rate of FCRS transmission, if the periodicity of the FCRS transmission is not at a maximum (1250). The rate increase message may be sent via the NB-CAI. The WTRU may determine whether to deactivate the WB TRX (1255). If the WTRU determines not to deactivate the WB TRX, the WTRU may continue the procedure and may send and/or receive control message with the gNB (1215). If the WTRU determines to deactivate the WB TRX, the WTRU may deactivate the WB TRX and stop the procedure (1260).

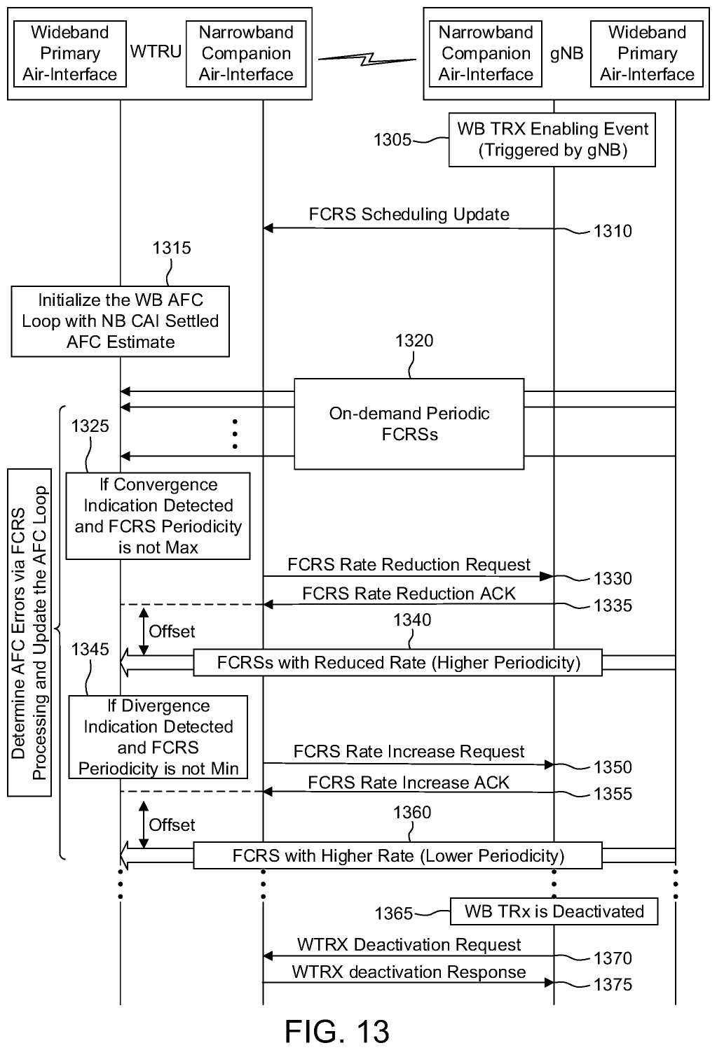

In an embodiment, a frequency error correction procedure for a WB-AI is shown in FIG. 13. As shown in FIG. 13, instead of a WTRU initiating a frequency error correction as in FIG. 11, a gNB may determine to activate a WB-AI for the WTRU and may initiate a procedure for frequency error correction. The gNB may send a scheduling update message to the WTRU (1310). The scheduling update message may be a FCRS Scheduling Update message. The FCRS Scheduling Update message may comprise schedule information regarding details of FCRS scheduling which may be at least one of: FCRS sequence information, periodicity, initial time offset, frequency domain allocation information; and beam information. The FCRS Scheduling Update message may be sent via a NB-CAI. After receiving the FCRS Scheduling Update message from the gNB, the WTRU may initialize an AFC loop of the WB-AI (1315). The WTRU may use an estimated frequency offset available for the NB-CAI. The WTRU may start receiving the periodic FCRSs over the WB-AI according to the schedule information provided in the FCRS Scheduling Update message (1320). The WTRU may perform measurements on the received FCRSs. The WTRU may check for a convergence or divergence indication. If a convergence indication is detected and the periodicity of the FCRS transmissions are not at a maximum (1325), the WTRU may send a rate reduction request to the gNB (1330). The rate reduction request may be a FCRS rate reduction request message. The rate reduction request may be sent via the NB-CAI. The WTRU may receive an ACK from the gNB (1335). The ACK may be a FCRS rate reduction ACK message. After receiving the ACK from the gNB, the WTRU may apply the new FCRS configuration with a reduced rate (e.g., with higher periodicity) after a configured offset (1340). If a divergence indication is detected at the WB-AI and the periodicity of the FCRS transmissions are not at a minimum (1345), the WTRU may send a rate increase request to the gNB (1350). The rate increase request may be a FCRS Rate Increase Request message. The rate increase request may be sent via the NB-CAI. The WTRU may receive an ACK message from the gNB (1355). The ACK may be a FCRS rate increase ACK message. If the WTRU receives the ACK message, the WTRU may apply the new configuration with an increased rate (e.g. with a lower periodicity) after a configured offset (1360). The gNB may determine to deactivate the WB TRX (1365). The gNB may send a WB TRX deactivation request message to the WTRU (1370). The gNB may release the FCRS resources. The WTRU may terminate the AFC loop, deactivate the WB-AI, and send a WB TRX deactivation response message to the gNB (1375).

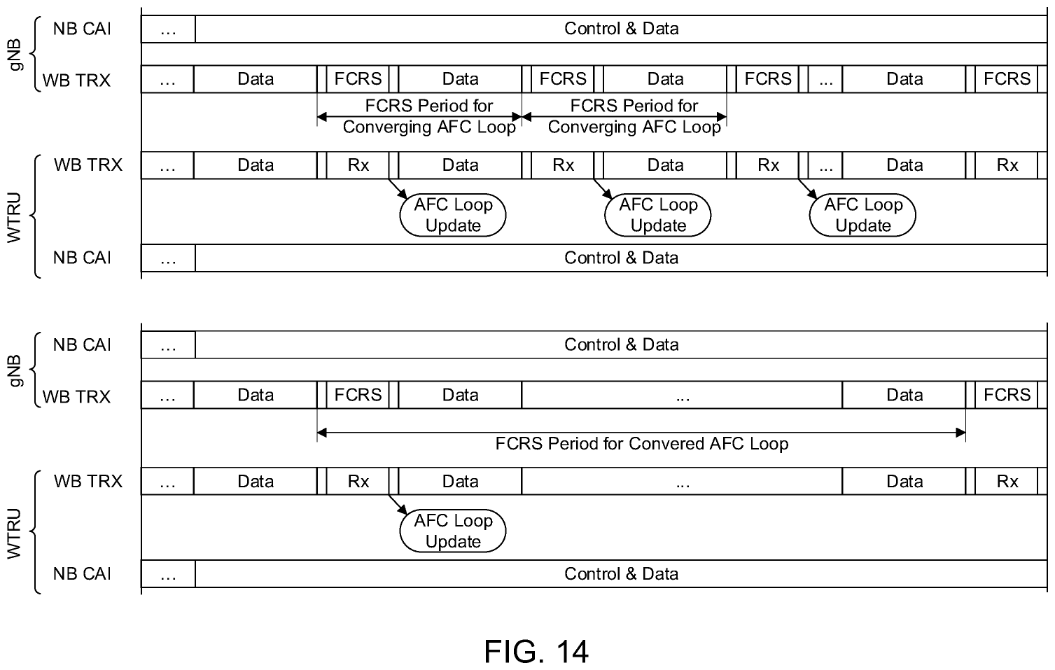

An example of FCRS transmission from a gNB and the reception at a WTRU with different states of convergence is shown in FIG. 14. As shown in the top part of FIG. 14, a rate of FCRS transmissions at the gNB and updates at the WTRU over a WB-AI are more frequent (e.g., with lower periodicity) when the AFC loop at the WTRU is in a converging state. Once the AFC loop is converged at the WTRU, the rate of FCRS transmissions from the gNB and updates at the WTRU side are set to a low value (e.g., with a maximum periodicity). The NB-CAI may be used to transmit and/or receive the associated control information.

The use of an averaging or smoothing function over several frequency error measurements may help filter out some of the VCO related noise and arrive at more stable FCRS configuration (e.g., periodicity) updates. However, there is a tradeoff between the number of frequency error measurements taken for that average and the latency in the FCRS configuration (e.g., periodicity) update. The number of frequency measurements may be proportional to the variance and may not exceed a threshold count, to reduce the delay in FCRS updates. The value of the threshold count may be configured by a gNB via, for example, a FCRS Scheduling Response/Update message, system information, or as a part of the higher layer signaling.

A relative movement (e.g., between the WTRU and a gNB) during the frequency convergence procedure may change the range of the WTRU. A change in the WTRU range may require change in the range-specific FCRS sequences. The WTRU may determine its range from the gNB using the periodic NB sequences received over a NB-CAI.

The WTRU may be configured with a threshold. If a change in the WTRU range (e.g., absolute difference between the current/recent range and the previously derived range) is above the threshold, the WTRU may be configured to send an update message (e.g., Range Update message) to the gNB. The Range Update message may comprise a flag or indicator (e.g., value ‘1’ for increment or value ‘0’ for decrement in the range).

In an example, multiple thresholds may be configured to the WTRU to represent a different level of change in the WTRU range. In this case, a multi-bit (e.g., multi-level) flag may be used at the WTRU to indicate the change in the range. For example, two-bit flags may be used to indicate a change in the range when two different thresholds (e.g., threshold5, threshold6) are configured to check against the change in the range. If the increment in the range is above the threshold5, the value ‘00’ may be used; if the increment in the range is above the threshold6 (>threshold5), the value ‘01’ may be used, and so on (with more thresholds and a greater number of bits for the flag indication). If the decrement in the range is above the threshold5, the value ‘10’ may be used; if the decrement in the range is above the threshold6 (>threshold5), the value ‘11’ may be used, and so on (with more thresholds and a greater number of bits for the flag indication).

In an example, the WTRU may include a preferred FCRS configuration (e.g., configuration ID) which may have the preferred FCRS sequence that may be used based on the WTRU range in the Range Update message for example, when the WTRU is configured with multiple FCRS configurations (e.g., a set of FCRS configurations) with different FCRS sequences (specific to different ranges). The WTRU may determine the preferred FCRS configuration based on the current range and the available set of configurations (e.g., with different FCRS sequence configurations). In an example, the WTRU may include the preferred FCRS sequence in the Range Update message for example, when the WTRU is configured with multiple FCRS sequences specific to different ranges. In an example, the WTRU may include the value of the current/latest range in the Range Update message.

The Range Update message may be transmitted over the NB-CAI. The Range Update Message may be transmitted using specific UL messages (e.g., specific MAC-CE, UL control information, higher layer signaling or specific UL sequences). The UL resources may be configured to the WTRU. Alternatively, the WTRU may send a request to a gNB to grant the UL resources to send a Range Update Message. In an example, specific UL sequences may be used to transmit the Range Update Message. One or more UL sequences may be configured by the network, for example, one sequence to indicate an increase in the range and another sequence to indicate a decrease in the range. Multiple UL sequences may be configured in a case of multi-level indications (e.g., with different level of increment or/and decrement in the WTRU range).

After sending a Range Update message over a NB-CAI, the WTRU may monitor for a DL response from the gNB over the NB-CAI. The DL Response may be received over a DL control channel (e.g. as a DL control information) or over a DL shared channel (e.g., as a MAC-CE message, or as a DL RRC message, etc.). The DL response may comprise an ACK indicating the request to change the FCRS configuration (e.g., FCRS sequence) is accepted by the gNB, or a NACK indicating that the request to change the FCRS configuration is not accepted by the gNB. In an example, the DL response from the gNB may comprise a configuration ID (e.g., if a set of configurations are pre-configured to the WTRU), FCRS sequence ID (e.g., if a set of FCRS sequences are pre-configured to the WTRU), or parameters (e.g., periodicity, initial offset, starting symbol/slot/sub-frame/frame, number or indices of symbols/slots/sub-frames/frames, density, bandwidth span, or FCRS sequence related parameters, etc.) associated with the updated FCRS configuration based on the WTRU request.

The WTRU may be configured with a maximum time offset or window for monitoring the reception of the DL response after sending the Range Update message. If the WTRU does not receive a response from the gNB within the configured maximum window/time offset, the WTRU may send another Range Update message (e.g., at a later time). The configuration of the maximum time offset or window (e.g., in terms of symbols/slots/sub-frame/frames or an absolute time value) may be communicated to the WTRU (e.g., in system information or as a part of the higher layer signaling).

If the response comprises the ACK or a granted/updated configuration is received by the WTRU, the WTRU may be configured with a time offset (e.g., in terms of symbols/slots/sub-frame/frames or in terms of absolute time unit) to determine when a new (e.g., updated/granted) configuration becomes active after receiving the response. The configuration of time offset may be communicated to the WTRU (e.g., in the response comprising the ACK or granted configuration, as a part of the higher layer signaling (e.g., RRC signaling), or in the system information, etc.). The WTRU may receive the FCRSs (e.g., using the WB-AI) configured as per the DL response message and may perform measurements for the frequency error correction procedure.

A WB-AI may be transitioned from an activated/active/connected state to an inactive/idle state. The WTRU or the gNB may initiate the transition of the WB-AI from the activated/active/connected mode to the inactive/idle state when for example, the WTRU or the gNB does not intend or have to transmit or receive any data using the WB-AI for a certain amount of time duration.

During the inactive state, the WB-AI at the WTRU may be configured to enter a sleep mode/state (e.g., deep-sleep mode/state, where a TRX is de-activated to reduce the power consumption). During the sleep mode, the WTRU may be configured to wake-up occasionally or periodically to monitor for one or more downlink signals (e.g., FCRSs) from the gNB. The configuration to wake-up (e.g., micro-sleep state) occasionally or periodically (e.g., DRX cycle or/and scheduling of the downlink signals to be monitored) may be provided to the WTRU by the gNB. The configuration of DRX cycle or/and scheduling of the downlink signals to be monitored for the WB-AI may be communicated to the WTRU via a NB-CAI.

Active state/mode DRX cycles may be configured for a WB-AI. The method described below for inactive state DRX cycles may also be performed for WB-AI active state DRX cycles (e.g., active mode DRX cycles).

The WTRU may perform frequency error correction procedure at a WB-AI with a serving cell during the WB-AI's inactive state.

In an example, a WTRU may be configured with downlink FCRS transmissions to be used during the WB-AI's inactive state by a gNB. The downlink FCRS transmissions to be used during the WB-AI's inactive state may be communicated to the WTRU before the transition of the WB-AI from an activated state to an inactive state. For example, the downlink FCRS transmissions to be used during the WB-AI's inactive state may be communicated as part of a RRC Release Connection Message or any other WB-AI deactivation message from the gNB that is used to configure the WTRU to switch the WB-AI from the activated/active state to the WB-AI's inactive state. In an example, the downlink FCRS transmissions to be used during the WB-AI's inactive state may be communicated to the WTRU via any other higher layer signaling (e.g., RRC message), system information, or downlink control information. The downlink FCRS transmissions to be used during the WB-AI's inactive state may be communicated to the WTRU by the gNB via a NB-CAI. The downlink FCRS configuration may comprise at least one or more of the parameters including: FCRS sequence or sequence generation parameters, periodicity (e.g., in terms of number of symbols/slots/sub-frames/frames), initial offset (e.g., in terms of number of symbols/slots/sub-frames/frames), starting symbol/slot/sub-frame/frame and number of symbols/slots/sub-frames/frames or symbol/slot/sub-frame/frame numbers/indices in case of non-consecutive allocation, bandwidth span (e.g., in terms of number of sub-carriers/resource elements/resource blocks), density which may be in terms of number of resource blocks, may be over a given bandwidth, or may include a number of resource elements per resource block, and/or may be indicated as one of the patterns where a set of patterns (e.g., a set of defined patterns of frequency allocation) may be configured to the WTRU (e.g., using system information or higher layer signaling).

In an embodiment, a WTRU may be pre-configured with multiple different configurations for the FCRS transmissions. For example, the configurations for the FCRS transmissions may comprise a set of FCRS scheduling configurations, where each FCRS scheduling configuration may include the value of one or more of: FCRS sequence or sequence generation parameters, periodicity, initial offset, starting symbol/slot/sub-frame/frame with number of symbol/slot/sub-frame/frame or symbol/slot/sub-frame/frame numbers/indices in case of non-consecutive allocation, bandwidth span, and density. Each FCRS scheduling configuration in the set of FCRS scheduling configurations may have a different value for at least one of the parameters compared to all other configurations in the set. Each FCRS scheduling configuration may have an identifier (e.g. configuration ID. The set of FCRS scheduling configurations may be communicated to the WTRU by a gNB, for example, via system information or higher layer signaling. The FCRS configuration for the WB-AI's inactive state may include the configuration ID associated with the FCRS scheduling configuration to be used/activated for the WB-AI's inactive state.

In an example, a WTRU may be configured to keep using the same downlink FCRS transmissions during the WB-AI's inactive state which the WTRU was using during the WB-AI's activated/active state before the transition from the activated/active state mode to the inactive state.

The WTRU may be configured to send a confirmation or acknowledgement (ACK) message to the gNB for the FCRS configuration if the WTRU determines to perform the frequency error correction procedure using the given FCRS configuration by the gNB during the WB-AI inactive state. In an example, the WTRU may send a negative acknowledgement (NACK) when for example, the WTRU determines to not perform the frequency error correction procedure during the WB-AI inactive state (e.g., in case WTRU wants to save the power) or the WTRU wants to perform the frequency error correction procedure using a different FCRS configuration (e.g., with a different periodicity). The WTRU may indicate its preference in the confirmation message (e.g., using a preferred FCRS configuration ID if the WTRU is configured with multiple FCRS configurations or including the parameters associated with the preferred configuration). The WTRU may monitor for an ACK from a gNB when for example, the WTRU sends its preferred FCRS configuration ID to the gNB. The uplink message comprising the ACK, NACK, or WTRU preference, and/or the downlink message with an ACK may be sent via a NB-CAI.

During the WB-AI's inactive state, the WTRU may wake-up (e.g., in micro-sleep mode) to receive FCRSs according to the FCRS schedule configured to the WTRU and may perform a frequency error correction procedure (e.g. an AFC convergence procedure). For example, the FCRSs may be scheduled one or more times in each or some DRX cycles. At each period of FCRS reception (e.g., at each reception of a FCRS burst), the WTRU may perform the correlation with the received FCRSs and may use the correlator output to estimate the frequency error.

In a case of transmission of FCRSs over multiple WB-AI beams, the additional scheduling information may be provided to the WTRU as part of the FCRS configuration. For example, the additional scheduling information may comprise at least one of: the information of beam or beams to be used to transmit the FCRSs over the WB-AI (e.g., beam IDs or reference beam/beams associated with another NB-CAI or another WB-AI), number of beams to be used for FCRSs transmissions, and scheduling of the FCRSs over beams. In an example, the WTRU may use FCRSs received using a best receive beam (e.g., highest RSRP) for the frequency error correction procedure. In an example, the WTRU may use FCRSs received using the multiple receive beams and may perform measurements (e.g. average measurements) over the multiple beams for the frequency error correction procedure.

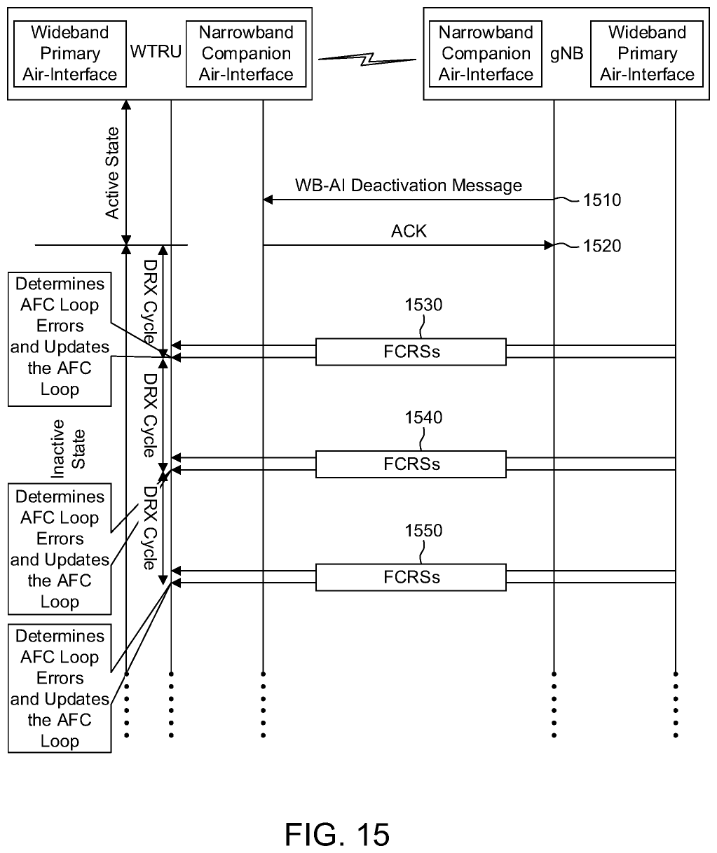

An example of FCRS configuration and reception is shown in FIG. 15. During a WTRU's WB-AI active state, the WTRU may receive a WB-AI deactivation command/message from a gNB (1510). The WB-AI Deactivation command/message may comprise scheduling information regarding the FCRS configuration for the WB-AI's inactive state (e.g. FCRS configuration information for an inactive state and DRX cycle information). The WB-AI deactivation command/message may be received via a NB-CAI. The WTRU may send an ACK message to the gNB to confirm that the WTRU will use the given configuration for the frequency correction during the WB-AI's inactive state (1520). Subsequently, the WTRU's WB-AI may enter an inactive state. During the inactive state, the WTRU may wake up in one or more DRX cycles, based on the FCRS scheduling configuration, to receive the FCRSs over the WB-AI and may perform frequency error correction (e.g. AFC loop) (1530, 1540, 1550).

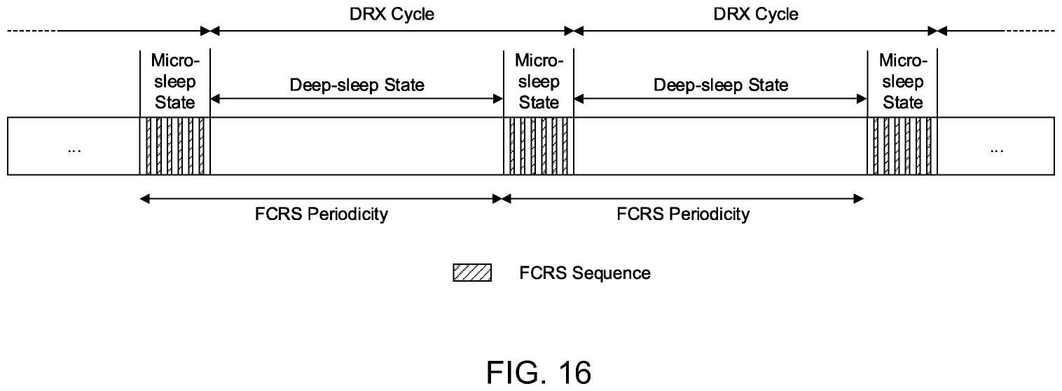

An example of FCRS scheduling is shown in the FIG. 16. A DRX cycle may comprise a deep-sleep state and a micro-sleep state. In each DRX cycle, the WTRU may wake-up from a deep-sleep state (e.g. and transition to a micro-sleep state) to receive the FCRSs according to a FCRS periodicity configuration. During the inactive state of the WB-AI, the WTRU may request to update the FCRS scheduling configuration. For example, the WTRU may request to decrease or increase the rate of FCRS transmissions (e.g., decrease or increase the periodicity of FCRS transmissions or number of FCRS transmissions in each period). In an example, the WTRU may determine to decrease the rate of FCRS transmissions when for example, the WTRU determines to save more power by increasing the deep-sleep duration. In an example, the WTRU may determine to increase or decrease the rate of FCRS transmissions based on measurements over the FCRSs, and may use a convergence indicator as described above.

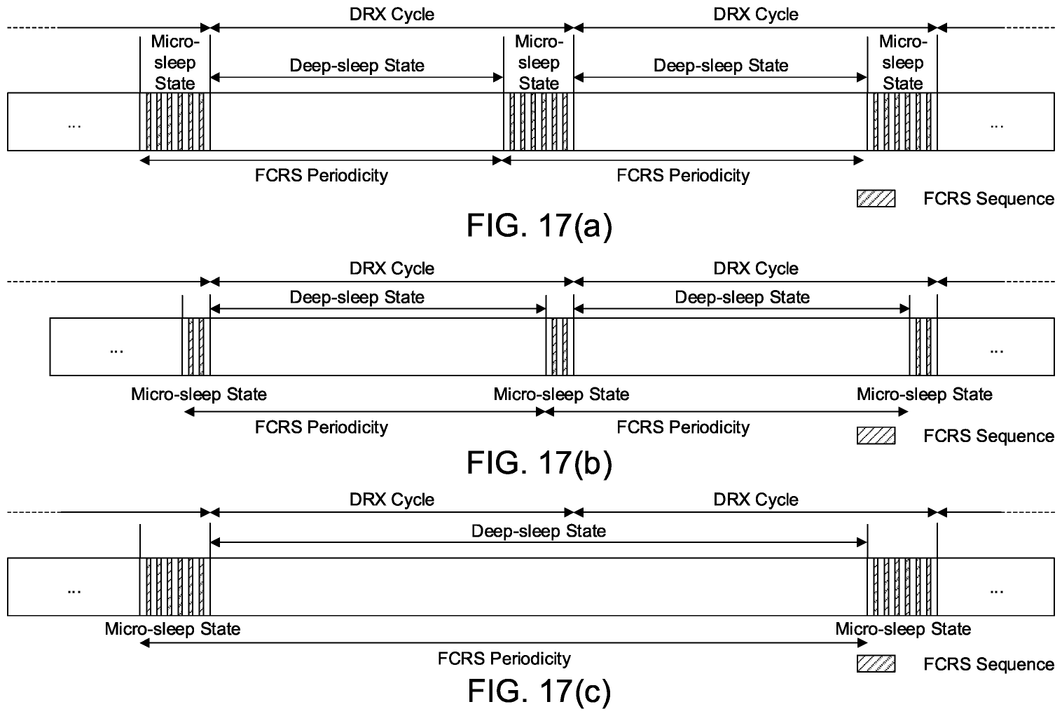

FIG. 17(a)-(c) shows examples of FCRS transmissions with different rates of transmissions. The configuration in FIG. 17(b) uses the same periodicity of FCRS transmission as shown in configuration of FIG. 17(a) but with a smaller number of FCRS transmission in each period. The configuration in FIG. 17(c) uses the same number of FCRS transmission in each period but the periodicity is increased by two times compared to the configuration shown in FIG. 17(a).

The value of a threshold (e.g., convergence or/and divergence threshold) used to determine to increase or decrease the rate of FCRS transmissions during the inactive state of WB-AI may be configured (e.g., if different from the activated/active state) by the gNB. The value of the threshold may be sent, for example, in a Connection Release or Deactivation message, via system information, or via higher layer signaling.

A request to increase or decrease the rate of FCRS transmissions during the WB-AI's inactive state may be sent to the gNB via a NB-CAI. In an example, the WTRU may indicate the request to increase or decrease by sending a flag (e.g., compared to a current rate of FCRS transmissions) to the gNB. In another example, the WTRU may use different indications (e.g., different combination of bits) to indicate the different rates of change of the FCRS transmissions (e.g., compared to current rate of FCRS transmissions) when for example, the WTRU is configured with multiple thresholds for the convergence or/and divergence indicators. In an example, the WTRU may send a preferred FCRS configuration (e.g., configuration ID) in the request when for example, the WTRU is configured with multiple FCRS configurations (e.g., a set of FCRS configurations). The WTRU may determine the preferred FCRS configuration based on the convergence indicator and the available set of configurations (e.g., with different rate of FCRS transmissions).

After sending a request to increase or decrease the rate of FCRS transmissions over a NB-CAI, the WTRU may monitor for a DL response from the gNB over the NB-CAI. The DL Response may be received over a DL control (e.g. DL control information) or over a DL shared channel (e.g., as a MAC-CE message, or as a DL RRC message). The DL response may comprise an ACK indicating the request to change the FCRS configuration is accepted by the gNB, or a NACK indicating that the request to change the FCRS configuration is not accepted by the gNB. In an example, the DL response from the gNB may comprise a configuration ID (e.g., if a set of configurations are pre-configured to the WTRU) or parameters (e.g., periodicity, initial offset, starting symbol/slot/sub-frame/frame, number or indices of symbols/slots/sub-frames/frames, density, bandwidth span, or FCRS sequence related parameters, etc.) associated with the granted (e.g., newly granted or allocated or updated) FCRS configuration based on the WTRU request.

The WTRU may be configured with a maximum time offset or window for monitoring the reception of the DL response after sending the request to increase or decrease the rate of FCRS transmissions. If the WTRU does not receive a response from the gNB within the configured maximum window/time offset, the WTRU may send another request (e.g., at a later time). The configuration of the maximum time offset or window (e.g., in terms of symbols/slots/sub-frame/frames or an absolute time value) may be communicated to the WTRU (e.g., in system information or as a part of the higher layer signaling).

If the response comprising an ACK or a granted (e.g., newly granted/updated/accepted) configuration is received by the WTRU, the WTRU may be configured with a time offset (e.g., in terms of number of DRX cycles or in terms of symbols/slots/sub-frame/frames or in terms of an absolute time unit) to determine when the new (e.g., newly granted/updated/accepted) configuration becomes active after receiving the response. The configuration of time offset may be communicated to the WTRU. The configuration of the time offset may be sent in the response comprising the ACK or granted configuration, as a part of the higher layer signaling (e.g., RRC signaling), or in the system information. The WTRU may receive the FCRSs (e.g., using the WB-AI) configured as per the DL response message and may perform measurements for the frequency error correction procedure.

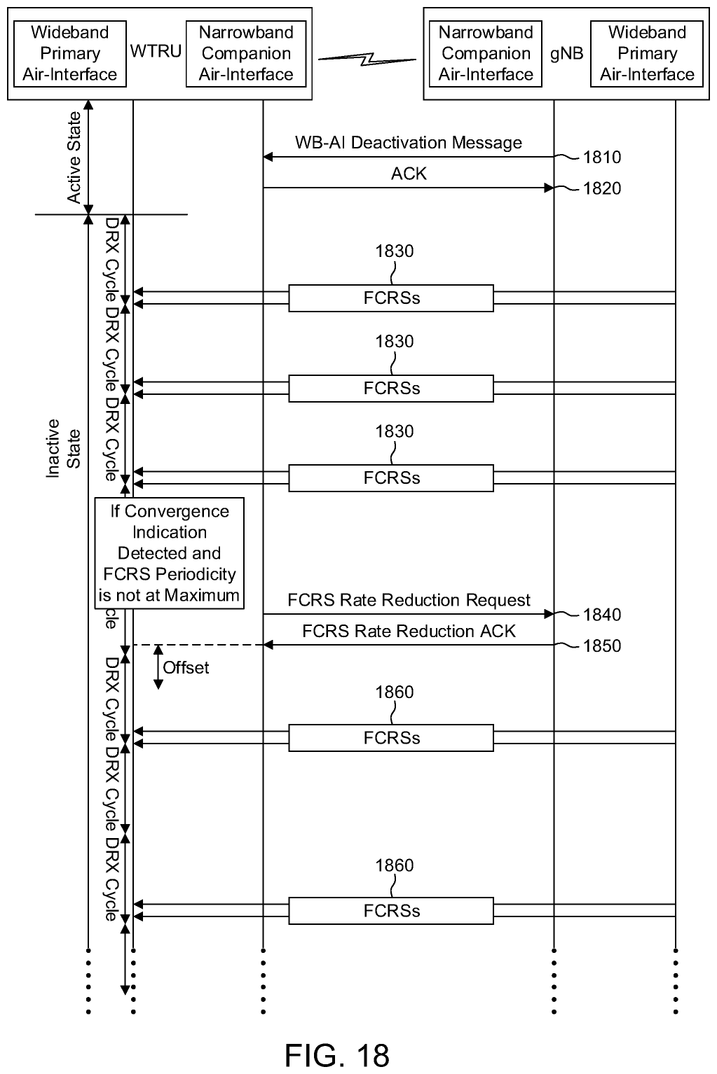

An example of FCRS rate adaptation during a WB-AI's frequency error correction during an inactive state is shown in FIG. 18. During a WTRU's WB-AI active state, the WTRU may receive a WB-AI deactivation command/message from a gNB (1810). The WB-AI deactivation command/message may comprise schedule information regarding the FCRS configuration for the WB-AI's inactive state (e.g. FCRS configuration information for an inactive state and DRX cycle information). The WB-AI deactivation command/message may be received via a NB-CAI. The WTRU may send an ACK message to the gNB to confirm that the WTRU will use the given configuration for the frequency correction during the WB-AI's inactive state (1820). Initially, the WTRU may be configured with FCRS transmission in every DRX cycle, therefore, the WTRU may wake up in every DRX cycle to receive the WB FCRSs according the FCRS schedule information (1830). The WTRU may perform measurements on the received FCRSs and also check for a convergence or divergence indication. If a convergence indication is detected during the frequency error correction procedure and the periodicity of the FCRS transmissions are not at a maximum, the WTRU may send a FCRS rate reduction request to the gNB via the NB-CAI (1840). The WTRU may receive an ACK from the gNB (1850). The ACK may be a FCRS rate reduction ACK message. After receiving the ACK from the gNB, the WTRU may apply the new FCRS configuration (e.g., with higher periodicity, the rate is reduced by one DRX cycle) after a configured offset. The WTRU may wake-up in every other DRX cycle to receive the FCRSs and perform frequency error correction (1860).

The DL beam used to communicate between the gNB and a WTRU over the WB-AI may be changed for example, due to a beam switch procedure (e.g., based on the UL measurements indicating the quality of one or more neighboring DL beams), or due to a beam failure detection and recovery procedure. The DL beam over the WB-AI used to communicate with the WTRU may be changed for example, due to the WTRU mobility (e.g., WTRU translational movement or/and WTRU rotational movement), blockages, or any other change in the radio environment.

The new DL beam identified by the gNB and a WTRU to communicate over the WB-AI (e.g., after a beam switch or beam recovery procedure) may or may not be quasi co-located (QCL'd) with the previous beam (e.g., used before the beam switch) over the WB-AI in terms of frequency offset error estimation, for example, both the new beam and the previous beam may have similar Doppler Shift or Doppler Spread.

FCRS configuration used to perform frequency error tracking/correction over the new beam may be different or the same compared to the FCRS configuration used over the previous beam. For example, if the new beam and the previous beam are QCL'd with respect to the parameters related to frequency offset error estimation, the FCRS configuration may have the same value of the parameters (at least the value of periodicity and number of transmissions within each period) used for the FCRS configuration over the previous beams before the beam switch happens.

In an example, if the new beam and the previous beam are not QCL'd with respect to the parameters related to frequency offset error estimation, the FCRS configuration may have different values for the parameters (at least the value of periodicity and number of transmissions within each period) used for the FCRS configuration over the previous beams before the beam switch happens. This may be because for example, a higher rate of FCRS transmissions may need to be configured for the new beam compared to the previous beam where a lower rate of FCRS transmissions were enabled due to the convergence indication.

During the beam switch procedure for the WB-AI, the WTRU may receive an indication from a gNB over a NB-CAI indicating whether the new beam QCL'd with the previous beam (e.g., used before the beam switch) with respect to the parameters related to frequency offset error estimation. The indication for the QCL may be communicated to the WTRU for example via higher layer signaling (e.g., RRC), downlink control information, or downlink MAC-CE. The WTRU may be configured (e.g., implicitly) to receive the WB-AI FCRSs using the same FCRS configuration (at least in terms of periodicity and number of transmissions within each period) that the WTRU was using over the previous beam when for example, the WTRU receives an indication from the gNB indicating that the new beam is QCL'd with the previous beam.

In an example, after or during the beam switch procedure for the WB-AI, the WTRU may receive a new WB-AI FCRS configuration for the new WB-AI DL beam from the gNB via a NB-CAI. The WTRU may receive the FCRSs on the new DL beam using the WB-AI based on the new FCRS configuration.

In an example, the WTRU may be configured to send a confirmation or acknowledgement (ACK) message to the gNB for the FCRS configuration of the new beam. For example, the WTRU may send a confirmation or acknowledgement (ACK) message after receiving a FCRS configuration from the gNB for the new beam when the WTRU agrees to use the configured FCRS configuration. In an example, the WTRU may send a confirmation or acknowledgement (ACK) message after receiving a QCL indication between the new beam and the previous beam (e.g., with respect to the parameters related to frequency offset error estimation) when the WTRU determines to use the same FCRS configuration over the new beam which the WTRU was using over the previous beam. In an example, the WTRU may send a request to configure FCRS transmissions with a high rate of transmissions (e.g., lower periodicity or/and higher number of transmissions in each period) after receiving a QCL indication between the new beam and the previous beam (e.g., with respect to the parameters related to frequency offset error estimation) for example when the WTRU is in high mobility or Doppler-shift scenarios. The WTRU may determine if the WTRU is in a high mobility scenario or not for example using the rate of cell-reselection, or/and using in-device gyroscope, or accelerometer. In the WTRU request, for example, the WTRU may send a flag indicating that the WTRU is in high mobility scenario. The gNB may configure a high rate of FCRS transmissions after receiving such indication. In an example, the WTRU may send a request comprising a configuration ID of a preferred FCRS configuration when for example, the WTRU is configured (e.g., pre-configured) with a set FCRS configurations (e.g., via system information or higher layer signaling). The WTRU may monitor for an ACK from the gNB when for example, the WTRU sends its preferred FCRS configuration ID to the gNB. The ACK or the WTRU request from the WTRU, or/and the FCRS configuration from the gNB may be sent via a NB-CAI.

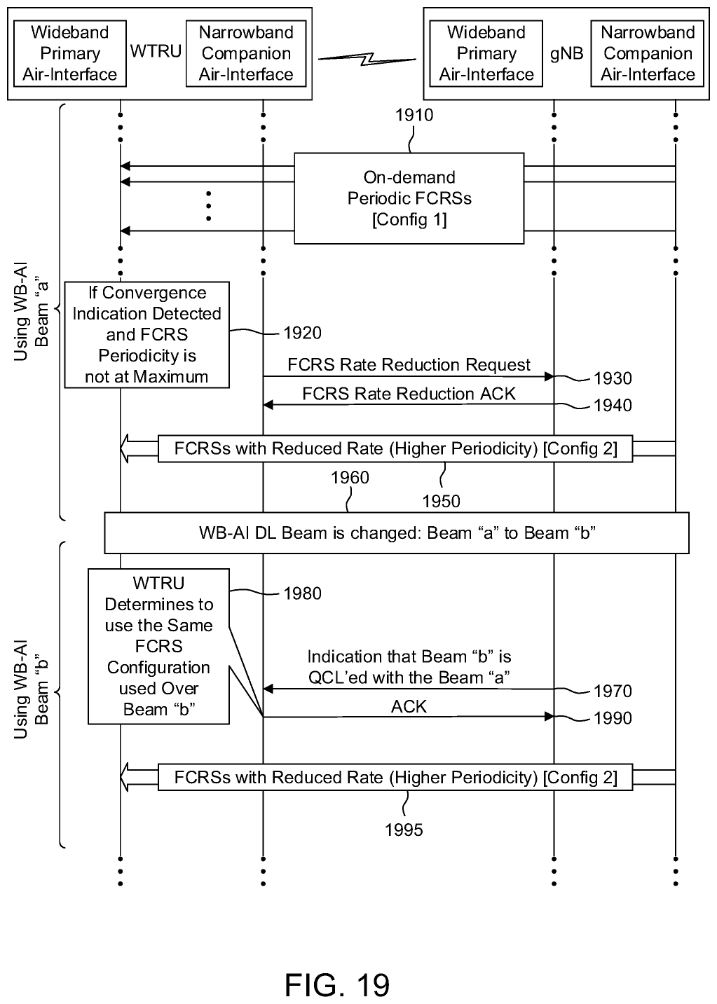

An example of a WB-AI FCRS configuration when beam switch occurs is shown in the FIG. 19. A WTRU may perform a frequency error correction procedure (e.g. AFC) over a first beam (e.g. beam “a”) using a first FCRS configuration (e.g. Config 1) (1910). The WTRU may detect a convergence indication (1920). The WTRU may determine that a FCRS periodicity is not at a maximum (1920). The WTRU may send a rate reduction request message to a gNB (1930). The rate reduction request message may be a FCRS rate reduction request message. The rate reduction request message may be sent via a NB-CAI. The WTRU may receive an acknowledgment (ACK) from the gNB (1940). The ACK message may be a FCRS rate reduction ACK message. The ACK message may be received over the NB-CAI. The WTRU may receive a second FCRS configuration (e.g. Config 2). The second FCRS configuration may be included in the FCRS rate reduction ACK message. The WTRU may perform a frequency error correction procedure (e.g. AFC) over beam “a” using the second FCRS configuration (Config-2) with a reduced rate (i.e. a reduced rate compared to the first FCRS configuration Config-1) (1950). The second FCRS configuration (Config 2) may have a higher periodicity (i.e. a higher periodicity compared to the periodicity of the first FCRS configuration Config 1). The WTRU may switch the WB-AI's beam to a second beam (e.g. beam “b”) (1960). The WTRU may receive an indication from the gNB that beam “a” is quasi co-located (QCL'd) with beam “b” in terms of frequency offset error related parameters (1970). After receiving the QCL indication, the WTRU may determine to use to a same FCRS configuration (i.e. Config-2 with a reduced rate) that the WTRU was using recently on beam “a” (1980). The WTRU may send an ACK message to the gNB (1990). The WTRU may receive FCRSs over beam “b” according to the second FCRS configuration (Config 2) (1995).

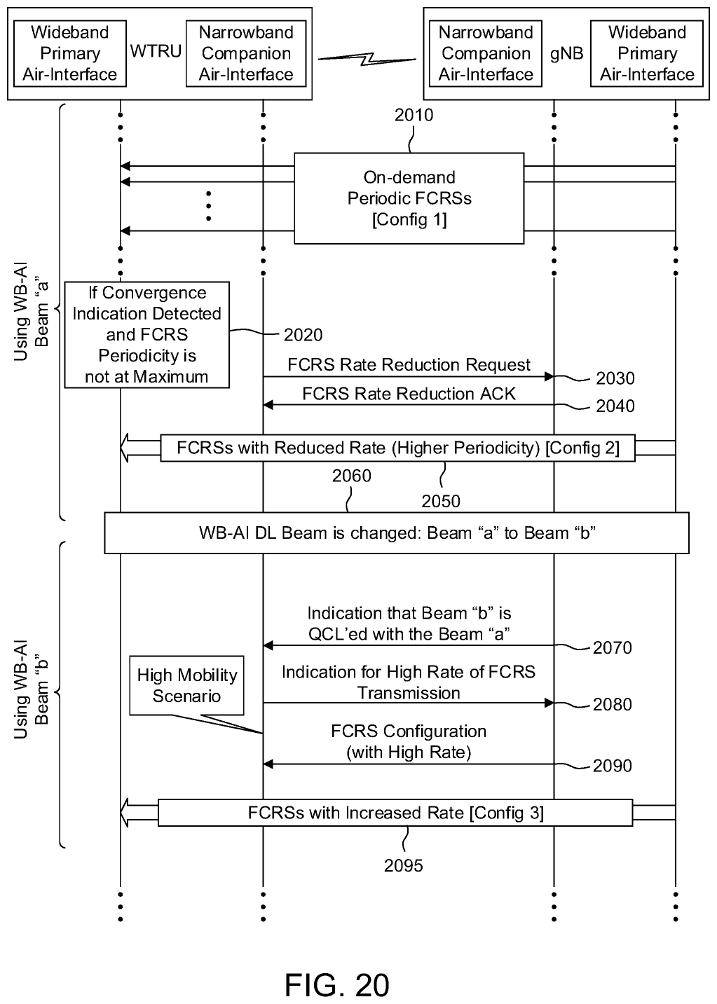

An example of a WB-AI FCRS configuration when beam switch occurs is shown in the FIG. 20. A WTRU may perform a frequency error correction procedure (e.g. AFC) over a first beam (e.g. beam “a”) using a first FCRS configuration (e.g. Config 1) (2010). The WTRU may detect a convergence indication (2020). The WTRU may determine that a FCRS periodicity is not at a maximum (2020). The WTRU may send a rate reduction request message to a gNB (2030). The rate reduction request message may be a FCRS rate reduction request message. The rate reduction request message may be sent via a NB-CAI. The WTRU may receive an acknowledgment (ACK) from the gNB (2040). The ACK message may be a FCRS rate reduction ACK message. The ACK message may be received over the NB-CAI. The WTRU may receive a second FCRS configuration (e.g. Config 2). The second FCRS configuration may be included in the FCRS rate reduction ACK message. The WTRU may perform a frequency error correction procedure (e.g. AFC) over beam “a” using the second FCRS configuration (Config-2) with a reduced rate (i.e. a reduced rate compared to the first FCRS configuration Config-1) (2050). The WTRU may switch the WB-AI's beam to a second beam (e.g. beam “b”) (2060). The WTRU may receive an indication from the gNB that beam “a” is QCL'd with the beam “b” in terms of frequency offset error related parameters (2070). The QCL indication message may be received over the NB-CAI. After receiving the QCL indication, due to a high mobility scenario, the WTRU may determine to use to FCRSs with higher rates of transmission compared to the second FCRS configuration Config-2 that the WTRU was using recently on beam “a”. The WTRU may send an indication for the higher rate of FCRS to the gNB (2080). The indication for the higher rate of transmission may be a rate increase request message. The rate increase request message may be sent over the NB-CAI. The WTRU may receive a third FCRS configuration (e.g. Config-3) with a higher rate of transmission (2090). The third FCRS configuration may be received over the NB-CAI. The WTRU may receive FCRSs over beam “b” according to the third FCRS configuration (Config-3) (2095).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a wireless transmit/receive unit (WTRU) using a narrowband companion air interface (NB-CAI) that supports a wideband air interface (WB-AI), wherein the NB-CAI and WB-AI operate over a same channel, the method comprising:
sending, via the NB-CAI to a network node, a scheduling request for a frequency convergence reference signal (FCRS) over the WB-AI;
receiving, via the NB-CAI, a scheduling response from the network node;
receiving, via the WB-AI, periodic FCRSs from the network node based on the received scheduling response; and
sending, via the NB-CAI, a request to the network node to change a rate of FCRS transmissions, wherein the request to change a rate of FCRS transmissions is based on a convergence indication.

2. The method of claim 1, wherein the scheduling response comprises at least one of: FCRS sequence information, a periodicity, an initial time offset, frequency domain allocation information, or beam information.

3. The method of claim 1, wherein the scheduling request comprises range information.

4. The method of claim 1, wherein an initial frequency offset is based on an estimated frequency offset error measured at the NB-CAI.

5. The method of claim 1, further comprising performing measurements on the received periodic FCRSs.

6. The method of claim 1, wherein the request to change a rate of FCRS transmissions is further based on a condition that a periodicity of the FCRS transmissions are equal to or below a maximum periodicity.

7. The method of claim 1, wherein the request to change a rate of FCRS transmissions comprises a configuration identification of a selected FCRS configuration from a set of FCRS configurations.

8. The method of claim 7, wherein the selected FCRS configuration is based on the convergence indication.

9. The method of claim 1, further comprising:
receiving an acknowledgement (ACK) from the network node in response to sending the request to change a rate of FCRS transmissions, wherein the ACK comprises a new FCRS schedule configuration; and
receiving periodic FCRSs from the network node based on the new FCRS schedule configuration.

10. The method of claim 1, wherein the convergence indication is based on a convergence threshold.

11. A wireless transmit/receive unit (WTRU) configured to use a narrowband companion air interface (NB-CAI) that supports a wideband air interface (WB-AI), wherein the NB-CAI and WB-AI operate over a same channel, the WTRU comprising:
a transceiver configured to send to a network node, via the NB-CAI, a scheduling request for a frequency convergence reference signal (FCRS) over the WB-AI;
the transceiver is further configured to receive, via the NB-CAI, a scheduling response from the network node;
the transceiver is further configured to receive, via the WB-AI, periodic FCRSs from the network node based on the received scheduling response; and
the transceiver is further configured to send, via the NB-CAI, a request to the network node to change a rate of FCRS transmissions, wherein the request to change a rate of FCRS transmissions is based on a convergence indication.

12. The WTRU of claim 11, wherein the scheduling response comprises at least one of: FCRS sequence information, a periodicity, an initial time offset, frequency domain allocation information, or beam information.

13. The WTRU of claim 11, wherein the scheduling request comprises range information.

14. The WTRU of claim 11, wherein an initial frequency offset is based on an estimated frequency offset error measured at the NB-CAI.

15. The WTRU of claim 11, further comprising a processor configured to perform measurements on the received periodic FCRSs.

16. The WTRU of claim 11, wherein the request to change a rate of FCRS transmissions is further based on a condition that a periodicity of the FCRS transmissions are equal to or below a maximum periodicity.

17. The WTRU of claim 11, wherein the request to change a rate of FCRS transmissions comprises a configuration identification of a selected FCRS configuration from a set of FCRS configurations.

18. The WTRU of claim 17, wherein the selected FCRS configuration is based on the convergence indication.

19. The WTRU of claim 11, wherein:
the transceiver is further configured to receive an acknowledgement (ACK) from the network node in response to sending the request to change a rate of FCRS transmissions, wherein the ACK comprises a new FCRS schedule configuration; and
the transceiver is further configured to receive periodic FCRSs from the network node based on the new FCRS schedule configuration.

20. The WTRU of claim 11, wherein the convergence indication is based on a convergence threshold.
